(19) United States
(12) Patent Application Publication
(10) Pub. No.: US 2002/0012327 A1
(43) Pub. Date: Jan. 31, 2002

(54) System and method of communications control

(76) Inventor: Hideaki Okada, Tokyo (JP)

Correspondence Address: BIRCH STEWART KOLASCH & BIRCH, PO BOX 747, FALLS CHURCH, VA, 22040-0747, US

(21) Appl. No.: 09/821,057

(22) Filed: Mar. 30, 2001

(30) Foreign Application Priority Data
Jul. 27, 2000 (JP) 2000-227045

(51) Int. Cl. H04Q 7/00; H04L 12/66; H04L 12/56

(52) U.S. Cl. 370/328; 370/352; 370/401

(57) ABSTRACT

Unicast path control for a mobile host is performed by inserting/deleting a path for each host in/from a unicast path table. A multicast group management table is managed by broadcasting a multicast address and a unicast address of a host which requests to receive a packet addressed to the multicast address, within the range where the communications control system according to the present invention can be applied. A multicast path table is created based on the unicast path table and the multicast group management table.

### BACKGROUND OF THE INVENTION

1. Field of the Invention

This invention relates to a system for controlling a path, reducing a packet loss and so on in the network, specially to the system in the mobile communications network.

2. Description of the Related Art

A wireless mobile host, such as a cellular phone, has become widespread in recent years. In accordance with this tendency, demand on data communications, for instance accessing to the Internet, has increased as well as calling in speech. In the future, since data communications having a wider band is to be realized by dint of a wireless technology progress, a multimedia service such as a dynamic image distribution will be provided to the mobile host.

In order to realize the multimedia service, managing host mobility (location) and keeping continuous communications when a mobile host in a wireless area transfers to another wireless area are important technological subjects.

Mobile IP (IETF RFC 2002:Internet Engineering Task Force Request for Comments 2002) is noted for dealing with the above technological subjects in the IP (Internet Protocol) network. According to Mobile IP, the mobility management is performed by exchanging control messages relating to location information, between a router called a home agent and a router called a foreign agent (or the mobile host itself. The home agent is a router in the network where the mobile host originally exists (or where the mobile host stays before transfer). The foreign agent is a router in the network to which the mobile host has transferred.

Therefore, if the mobile host frequently transfers from one network to another network (or other networks), a large number of control messages relating to the location information of the frequent host transfer, may be transmitted and received, which makes the network traffic increase. In the case of the mobile host being far from the home agent, a wide area may be affected and it may take a long time to send and receive control messages. Namely, it is thought that Mobile IP is inadequate for managing the frequent and high rate transfer. In recent years, a protocol such as Cellular IP or a protocol based on a Mobile IP hierarchy has been introduced. Cellular IP is described in a paper entitled “An Overview of Cellular IP” by Andrew T. Campbell and Javier Gomes, IEEE Wireless Communications and Networking Conference (WCNC in 1999).

In the case of distributing the same data to a large number of hosts, such as a dynamic image distribution case or a news distribution case, it is desirable to utilize the technology of multicast. Though this case of distributing the same data to many hosts can be realized by respectively transmitting the data to each host, a large number of the same data are transmitted in the network. Therefore, it is desirable to use the technology of multicast.

The multicast (IP multicast) in the IP network is composed of multicast group management and multicast path control. In the multicast group management, a multicast router which can perform routing a multicast packet (a packet addressed to a multicast address) manages whether a node in a subnet managed by the multicast router belongs to the multicast group or not. IGMP (Internet Group Management Protocol) is used in the multicast group management as a standard protocol. (RFC 2236). In the multicast path control, it is decided which path should be used for transmitting a multicast packet to the multicast router. Various protocols, such as DVMRP (Distance vector multicast routing protocol: RFC 1075), MOSPF (Multicast Extensions to OSPF: RFC 1584) have been suggested to be used in the multicast path control.

However, since the multicast path control protocols stated above are mainly intended to be used for a fixed host, the host mobility (location) management and the continuous communications keeping in the case of the mobile host transferring to another wireless area, which have been stated as the important technological subjects, are not specially taken into consideration in the multicast path control protocols stated above.

In order to realize the IP multicast in the network where hosts transfer frequently and rapidly, the subjects of the host mobility (location) management and the continuous communications keeping should be studied and solved for the multicast case as well as the case of unicast. However, the subjects of the IP multicast have not been considered so much as the IP unicast case.

Thus, one of objects of the present invention is to provide a communications system where the communications control, particularly the multicast path control, is effectively performed, the host transfer is quickly dealt with, and data loss at the time of the host transferring to other wireless communications area is reduced.

### SUMMARY OF THE INVENTION

A communications control system according to one aspect of the present invention comprises:

a unicast path memory for storing unicast path information which relates to a combination of a host address (of a host) to which data is transmitted and an output destination interface indicating a network interface used as a path for transmitting the data to the host address,

a multicast group management memory for storing multicast group information which relates to a combination of the host address and a multicast address to which the host belongs,

a multicast path memory for storing multicast path information which relates to a combination of the multicast address and the output destination interface, and

a multicast path controller for obtaining the multicast address and the host address corresponding to the multicast address from the multicast group management memory, obtaining the output destination interface corresponding to an obtained host address from the unicast path memory, and storing a combination of an obtained multicast address and an obtained output destination interface (or a plurality of output destination interfaces) as the multicast path information in the multicast path memory.

According to another aspect of the present invention, the communications control system further comprises a multicast group management part for receiving a notification message of belonging to multicast group including the host address and the multicast address, obtaining the host address and the multicast address from a received notification message of belonging to multicast group, and storing a combination of an obtained host address and an obtained multicast address as the multicast group information in the multicast group management memory.

According to another aspect of the present invention, the communications control system comprises:

a multicast path memory for correspondingly storing a multicast address and an output destination interface (or a plurality of output destination interfaces) indicating a network interface (or a plurality of network interfaces) used as a path (or a plurality of paths) for transmitting data addressed to the multicast address, and

a multicast path controller for receiving a notification message of belonging to multicast group, which includes the multicast address and indicates that a host address of a host belongs to the multicast address, obtaining the multicast address from a received notification message of belonging to multicast group, detecting the network interface which received the notification message of belonging to multicast group as the output destination interface, and correspondingly storing an obtained multicast address and a detected output destination interface in the multicast path memory.

According to another aspect of the present invention, the communications control system further comprises:

a plurality of routers, each of which has the multicast path memory and the multicast path controller, for mediating to transmit data in a specific network, and

a gateway, which has the multicast path memory and the multicast path controller, for connecting the specific network with another network,

wherein each of the plurality of routers receives the notification message of belonging to multicast group and transmits a received notification message of belonging to multicast group to another of the plurality of routers, in order to finally transmit the notification message of belonging to multicast group to the gateway.

In the communications control system according to another aspect of the present invention, the multicast path controller receives a multicast path management message including a multicast path management notification for managing the multicast path memory, and manages the multicast path memory based on a received multicast path management message.

A communications control method according to one aspect of the present invention comprises the steps of:

creating a memory area of a unicast path memory,

storing unicast path information which relates to a combination of a host address of a host to which data is transmitted and an output destination interface indicating a network interface used as a path for transmitting the data to the host address, in the unicast path memory,

creating a memory area of a multicast group management memory,

storing multicast group information which relates to a combination of the host address and a multicast address to which the host belongs, in the multicast group management memory,

creating a memory area of a multicast path memory,

obtaining the multicast address and the host address corresponding to the multicast address from the multicast group management memory,

obtaining the output destination interface corresponding to an obtained host address, from the unicast path memory, and

storing an obtained multicast address and an obtained output destination interface as multicast path information in the multicast path memory.

The above-mentioned and other objects, features, and advantages of the present invention will be made more apparent by reference to the following detailed description when taken in conjunction with the accompanying drawings.

### BRIEF DESCRIPTION OF THE DRAWINGS

In the drawings,

FIG. 1 shows a network configuration example;

FIG. 2 shows an example of unicast path table;

FIG. 3 shows an example of procedure for creating a multicast path table according to Embodiment 1;

FIG. 4 shows a configuration example of a router according to Embodiment 1;

FIG. 5A shows an example of a notification message according to Embodiment 1;

FIG. 5B shows an updating example of a multicast group management table according to Embodiment 1;

FIG. 6 shows a flow of creating the multicast path table according to Embodiment 1;

FIG. 7 shows an example of multicast group management table according to Embodiment 2;

FIG. 8 shows an example of control message according to Embodiment 3;

FIG. 9 shows an example of procedure for creating a multicast path table according to Embodiment 4;

FIG. 10 shows a configuration example of a router according to Embodiment 5;

FIG. 11 shows an updating example of a pseudo-unicast path table according to Embodiment 5;

FIG. 12 shows a configuration example of a router according to Embodiment 6;

FIG. 13A shows an example of multicast path table before updating according to Embodiment 6;

FIG. 13B shows an example of multicast path table after updating according to Embodiment 6;

FIG. 14 shows an example of control message according to Embodiment 6;

FIG. 15 shows an example of updating flow of a multicast path table according to Embodiment 6;

FIG. 16 shows an example of updating (deletion) flow of a multicast path table according to Embodiment 6;

FIG. 17 shows an example of updating (addition) flow of a multicast path table according to Embodiment 6;

FIG. 18 shows a flow example of periodically transmitting a control message according to Embodiment 6;

FIG. 19 shows a configuration example of mobile host according to Embodiment 6;

FIG. 20 shows an example of updating procedure of multicast path table according to Embodiment 6;

FIG. 21 shows a configuration example of mobile host according to Embodiment 7;

FIG. 22 shows an example of updating procedure of multicast path table according to Embodiment 7;

FIG. 23 shows an example of control message according to Embodiment 8;

FIG. 24 shows an example of updating procedure of multicast path table according to Embodiment 8;

FIG. 25 shows a configuration example of base station according to Embodiment 9;

FIG. 26 shows an example of updating procedure of multicast path table according to Embodiment 9;

FIG. 27 shows an example of updating procedure of multicast path table according to Embodiment 10; and

FIG. 28 shows an example of updating procedure of multicast path table according to Embodiment 11.

### DETAILED DESCRIPTION OF PREFERRED EMBODIMENTS

Embodiment 1

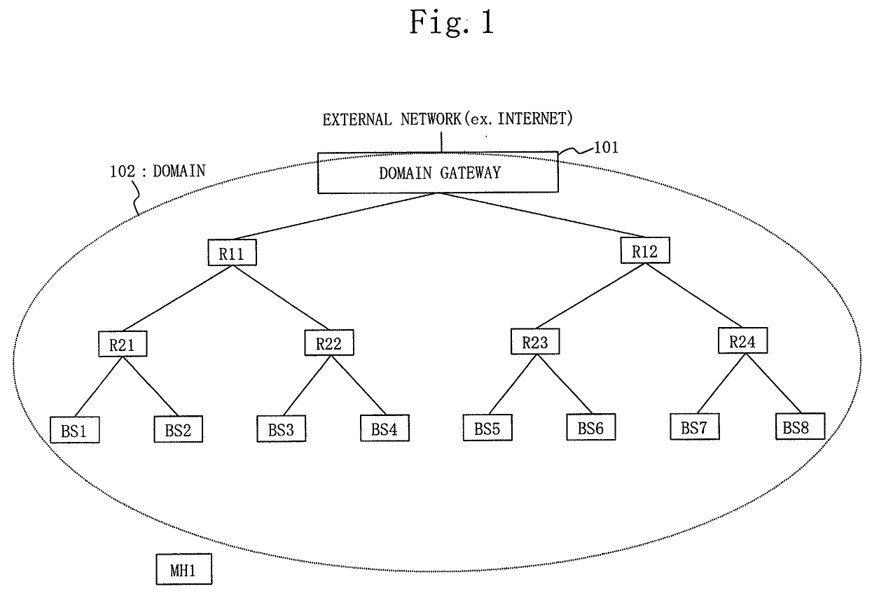

FIG. 1 shows a configuration example of network where Embodiments of the present invention can be applied. A domain 102 is composed of a domain gateway 101, routers R11, R12, R21, R22, R23 and R24, and base stations BS1 through BS8. In the Embodiments of the present invention, it is supposed that one communications control system is applied in a domain. In other words, a network managed by one communications control system is called a domain.

The domain 102 is connected to an external network through the domain gateway 101. Namely, the domain gateway 101 can be regarded as a router. Each of the base stations BS1 through BS8 includes a wireless communications unit and can have wireless communications with a mobile host MH1. Further, each of the base stations BS1 through BS8 can receive data from the mobile host MH1 by wireless, transfer the received data to an upper router if necessary, or transfer data received from the upper router to the mobile host MH1 by wireless. A host in this specification indicates a device, such a mobile host, a mobile terminal or a mobile computer, which can have communications with a base station. Though communications between the host and the base station by wireless will be described in the following explanation as an example, the case of having communications by wire between them can also be acceptable.

Considering the case that the mobile host MH1 moves not only within the domain 102 but also into other domain, a protocol which manages the mobility of the mobile host MH1 between domains, may be applied. For instance, in the case of Mobile IP being applied, the domain gateway 101 may operate as a foreign agent of the Mobile IP, or when no foreign agent exists, the mobile host MH1 may operate with keeping a co-located CoA (Care-Of-Address). Such Mobile IP is called a Mobile IP between domains.

It is also supposed that a mobility management protocol such as Cellular IP which utilizes an entry of path specified by a host (host address) designation is applied in the network as shown in FIG. 1. Namely, it is supposed the mobile host MH1 transfers with using the same address. According as the mobile host MH1 transfers, the base station with which the mobile host MH1 can have communications is changed to another one, or the subnet to which the base station is connected is changed to another one. The subnet generally indicates a part of the network where routing can be performed by a prefixed address (network address).

As a usual case, particularly in the Internet, a path is managed by an entry of path specified by a network (network address) designation, not by a host (host address) designation, because it is necessary to avoid a path table necessary for controlling paths becoming large. It is possible to make the path table smaller (ex. one/254^{th}) by keeping a path for the network address 1. 2. 3. 0 than keeping paths for two hundred and fifty-four hosts of addresses 1. 2. 3. 1 through 1. 2. 3. 254. (In here, 254 is stated as an example, and it is not limited to this value.)

The mobility management protocol utilizing an entry of path specified by a host designation, such as Cellular IP, can perform the routing for each address by inserting a path entry of each host into the path table. This path entry is deleted when it becomes unnecessary. The deletion based on a time limit can also be performed, and there is a method of periodically updating the path entries in order to avoid the deletion based on the time limit.

For instance, when the mobile host MH1 comes to be able to have communications with the base station BS1, the mobile host MH1 informs the base station BS1 of the mobile host's having transferred into the area of the base station BS1, by way of transmitting a control message. Then, the base station BS1 transmits the control message to the domain gateway 101. This control message is transmitted to the domain gateway 101 with performing some processing at the routers R21 and R11. An entry relates to the path for the mobile host MH1 is added in the path tables of the routers R21 and R11. Of course, the entry relates to the path for the mobile host MH1 is added in the path table of the domain gateway 101.

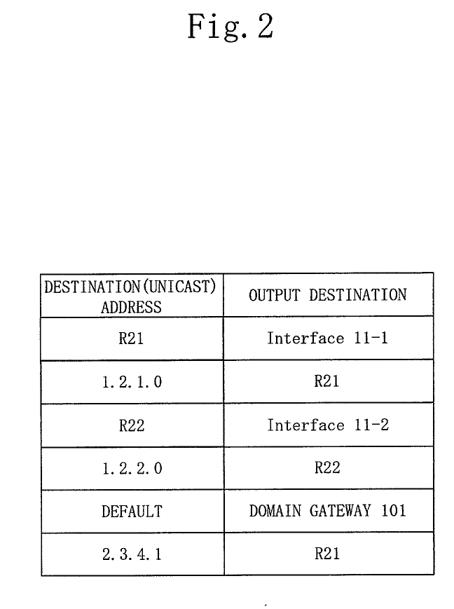

FIG. 2 shows an example of a part of the path table (excerption) applying the mobility management protocol utilizing an entry of path specified by a host designation. The table shown in FIG. 2 is supposed to be a path table for the router R11. The entries of path specified by network (network address) designation are 1. 2. 1. 0, and 1. 2. 2. 0, which respectively perform routing to the router R21 and the router R22. Since it is necessary to have entries for transmitting to R21 and R22, the network interface at the router R21's side of the router R11 is described as Interface 11-1 and the network interface at the router R22's side of the router Rh is described as Interface 11-2, in the output destination column in FIG. 2.

Besides, a default path entry is prepared in order to transmit a packet which is not applicable to any address. The default path entry is routed to the domain gateway 101. The path entries having been stated up to this stage are for general fixed hosts. Then, an entry of path specified by a host designation for the mobile host MH1 is added to the path table. It is registered that a packet addressed to 2. 3. 4. 1 of the mobile host MH1 is to be transmitted to R21.

In this specification, a router indicates an intermediary device for transferring data (packet) addressed to a unicast address or a multicast address, and a router can be a gateway. The base station which receives and transmits data from/to the mobile host may also be regarded as a router utilizing the upper router as an output interface and having a wireless output interface to the mobile host instead of having an output destination interface to the lower router.

The control message is a generic name of message controlling each router and indicates a packet for the management. A packet of data to be distributed is not the control message. Based on the above stated premise, the communications control system of Embodiment 1 will now be explained.

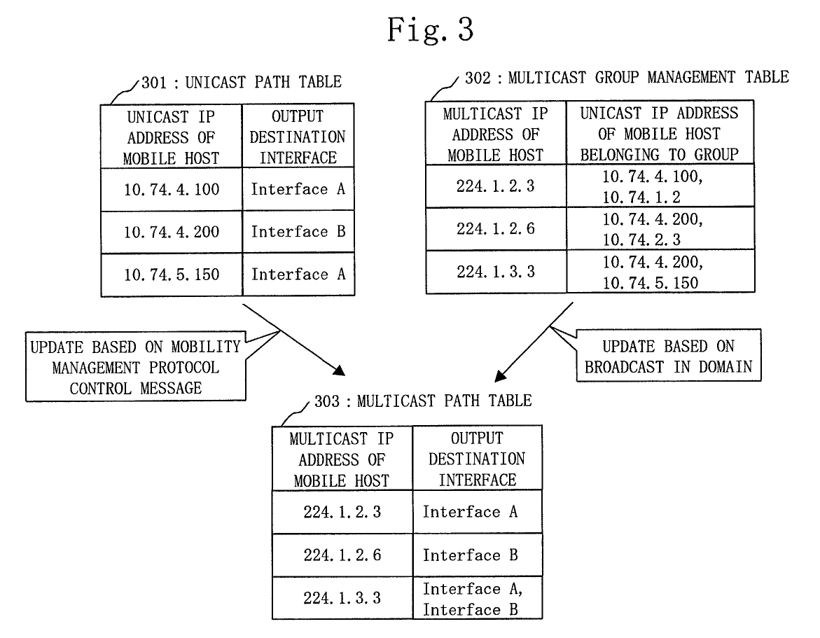

FIG. 3 shows an example of creating a multicast path table according to Embodiment 1. Though a unicast path table 301 in FIG. 3 is the same as the path table in FIG. 2, it is more simplified than FIG. 2 for the explanation. For instance, in FIG. 2, a packet addressed to 2. 3. 4. 1 of the mobile host is to be transferred to the router R21. It is possible to transfer the packet to the router R21 by outputting the packet to the network Interface 11-1 of the router R21. Namely, the packet addressed to the address 2. 3. 4. 1 can be transferred by being output to the network Interface 11-1.

In the unicast path table (unicast path memory) 301, an address (unicast IP address) and a network interface to be output (output destination interface) are correspondingly described. A combination of a host address of a host to which data is transmitted and an output destination interface indicating a network interface used as a path for transmitting the data to the host address is stored in the unicast path table, as unicast path information. The number of combinations stored in the unicast path information can be one or plural.

A multicast group management table (multicast group management memory) 302 manages a multicast address (multicast IP address) and an address of each host (unicast IP address) belonging to a multicast group requesting to receive a packet addressed to the multicast address. It is supposed that each of the routers in the domain 102 keeps the multicast group management table having the same contents. A combination of a host address of a host and a multicast address to which the host belongs is stored in the multicast group management table, as multicast group information. The number of combinations stored in the multicast group information can be one or plural. The combination can be composed of a multicast address and a host address, or a multicast address and host addresses.

In a multicast path table (multicast path memory) 303, a combination of a multicast address and an output destination interface is stored as multicast path information. The number of combinations stored in the multicast path information can be one or plural. The multicast path table 303 will be explained later in detail. It is assumed that each of the routers in the domain 102 has the three tables 301, 302, and 303.

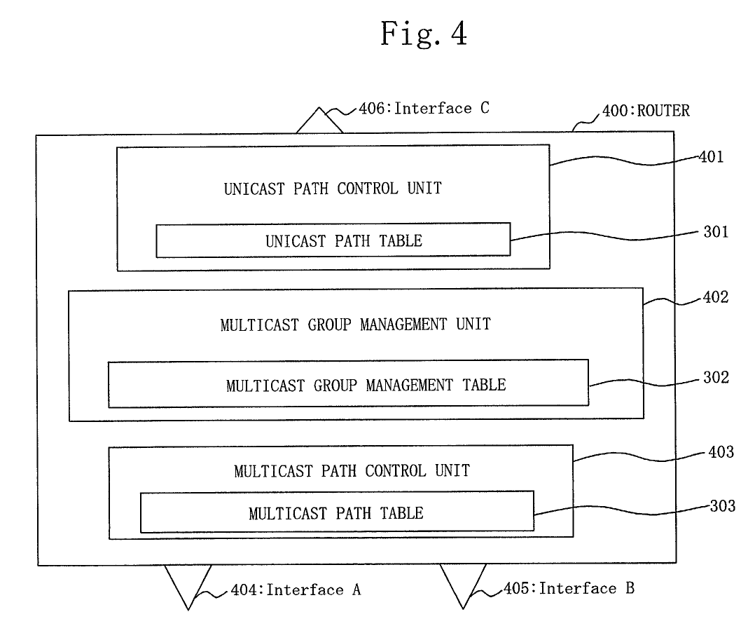

FIG. 4 shows a configuration example of a router 400. For instance, in the hierarchical structure network as shown in FIG. 1, network interfaces A404 and B405 for having communications with lower routers or hosts and a network interface C406 for having communications with an upper router or a domain gateway are provided for the router 400. A unicast path control unit (unicast path controller) 401 for managing the unicast path table 301, a multicast group management unit (multicast group management part) 402 for managing the multicast group management table 302, and a multicast path control unit (multicast path controller) 403 for managing the multicast path table 303 are provided in the router 400.

In the explanation below, the unicast IP address indicates the same as the unicast address, and the multicast IP address indicates the same as the multicast address. When the mobile host MH1 has transferred to the communication area covered by the domain 102 in the network of FIG. 1, the mobile host MH1 broadcasts its own address and an address (multicast address) of multicast group to which the mobile host MH1 wants to belong, to all the routers in the domain 102.

Concretely, the mobile host MH1 transmits its own address and the multicast address, as a notification message of belonging to multicast group, to the base station such as the base station BS1 with which the mobile host MH1 can have communications. Then, the base station BS1 transmits the notification message of belonging to multicast group, to the domain gateway 101. The domain gateway 101 broadcasts the notification message to all the routers in the domain 102. Otherwise, when the address of the domain gateway 101 is announced by the base stations, it is also acceptable for the mobile host MH1 to know the address of the domain gateway 101 based on the announcement, and to directly transmit the notification message of belonging to multicast group, to the address of the domain gateway 101. Then, the domain gateway 101 broadcasts the notification message to all the routers in the domain 102. On receiving the notification message transmitted from the mobile host MH1, each router in the domain updates the multicast group management table 302. (multicast group storing step).

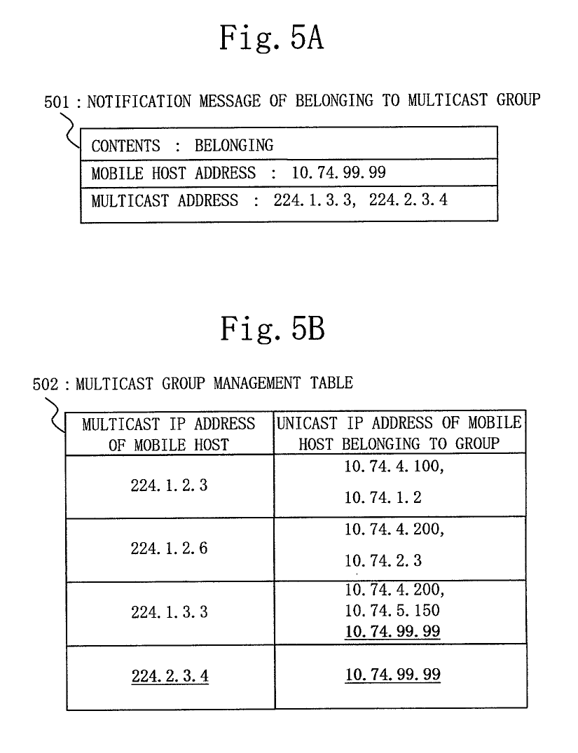

An example of updating the multicast group management table 302 by the multicast group management unit 402 will now be explained with reference to FIGS. 5A and 5B. It is supposed that the mobile host address 10. 74. 99. 99 and one or more than one multicast addresses (ex. 224. 1. 3. 3, 224. 2. 3. 4 in FIG. 5A) are included in a notification message 501 of belonging to multicast group. The notification message 501 of belonging to multicast group is one of the control messages. If the multicast address in FIG. 5A has not been registered in a multicast group management table 502 of FIG. 5B, a new entry is created in FIG. 5B for the multicast address, and the address of the mobile host is registered in the unicast IP address column corresponding to the multicast address. (ex. the combination of the underlined 224. 2. 3. 4 and 10. 74. 99. 99). When the multicast address has been already registered in the multicast group management table 502, the address of the mobile host is added in the unicast IP address column corresponding to the multicast address. (ex. the underlined 10. 74. 99. 99 is added for the multicast address 224. 1. 3. 3)

When the mobile host leaves the domain 102, the mobile host broadcasts a notification message of withdrawing from multicast group. The notification message of withdrawing from multicast group includes the mobile host address and the multicast address. Receiving the notification message of withdrawing from multicast group, each router deletes information relating to the mobile host from the multicast group management table 302.

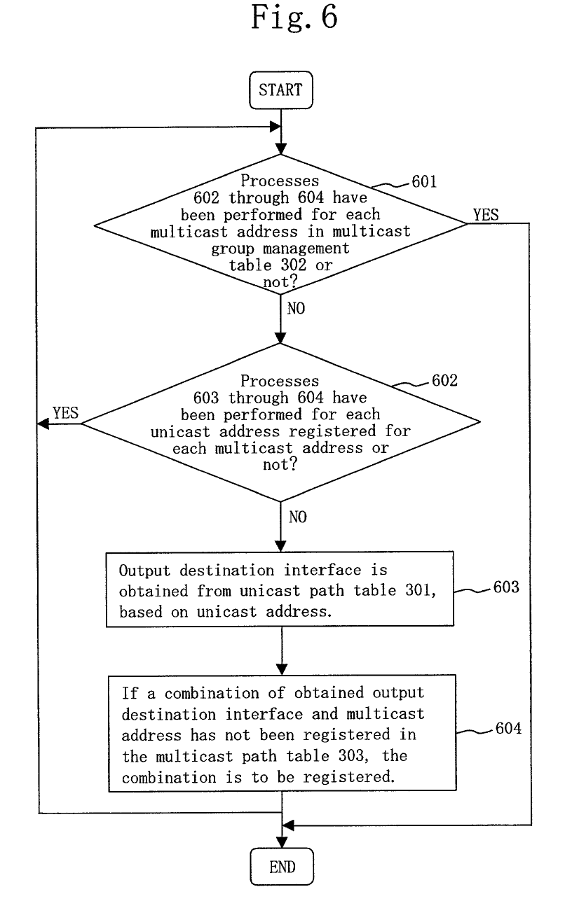

The way of creating the multicast path table 303 by the multicast path control unit 403 will now be explained with reference to FIG. 6.

At 603, an output destination interface of a combination of a multicast address and a unicast address registered in the multicast group management table 302 is obtained from the unicast path table 301, based on the unicast address. At 604, if a combination of the obtained output destination interface and the multicast address relating to this output destination interface has not been registered in the multicast path table 303, the combination is to be registered. (multicast path storing step)

For instance in FIG. 3, the unicast address 10. 74. 4. 100 is registered to be corresponding to the multicast address 224. 1. 2. 3 in the multicast group management table 302. In the unicast path table 301 of FIG. 3, an output destination interface A is registered to be corresponding to the unicast address 10. 74. 4. 100. This means that the host appointed by the unicast address 10. 74. 4. 100 exists to be lower than the base station which is connected to be lower than the network interface A. In this case, a router can exist between the network interface A and the base station. Accordingly, a packet addressed to the multicast address 224. 1. 2. 3 has to be output to the network interface A. Therefore, the interface A is registered in the multicast path table 303 as an output destination interface corresponding to the multicast address 224. 1. 2. 3.

At 601, the processes 602 through 604 in FIG. 6 are performed for each multicast address in the multicast group management table 302. At 602, the processes 603 through 604 in FIG. 6 are performed for each unicast address registered for each multicast address. In this way, the multicast path table 303 which is necessary for routing the multicast packet can be created.

The unicast path table 301 is updated based on a path control protocol of the unicast regardless of the multicast. (unicast path storing step)

The multicast group management table 302 can be structured by broadcasting information relating to the mobile host's leaving and entering a domain only when the mobile host leaves and enters the domain. The multicast path table 303 can be created by calculation based on the unicast path table 301 and the multicast group management table 302. The control message necessary only for creating the multicast path table is broadcast only when the mobile host leaves and enters the domain. Accordingly, the multicast path table can be effectively created with respect to traffic of the control message.

Generally, the multicast group management table 302 for the mobile host is hardly rewritten after the table 302 has been broadcast once. Then, by way of updating the multicast path table 303 at the timing of the mobility management protocol being rewritten, the multicast path table 303 can be maintained to be promptly corresponding and adapting to the mobile host movement.

As stated above, the communications control system according to Embodiment 1 has the following features: the unicast path control for the mobile host is performed by inserting/deleting a path for each host in/from the unicast path table 301. The multicast group management table 302 is managed by broadcasting a multicast address and a unicast address of a host which requests to receive a packet addressed to the multicast address, within the range where the communications control system according to the present Embodiment can be applied. The multicast path table 303 is created based on the unicast path table 301 and the multicast group management table 302. In addition, the multicast path table 303 is updated at the timing of the unicast path table 301 being updated.

According to the communications control system, the router, and the communications method of the present Embodiment, a multicast path can be updated based on a unicast path memory and a multicast group management memory.

According to the multicast group management unit in the communications control system of the present Embodiment, a multicast group can be updated based on a notification message of belonging to multicast group.

According to the multicast group management unit in the communications control system of the present Embodiment, it is possible to notify a change of multicast group within a specific network, by broadcasting a received notification message of belonging to multicast group.

According to the multicast path control unit in the communications control system of the present Embodiment, a multicast path can be updated corresponding to the timing of updating a unicast path.

According to the communications control system of the present Embodiment, a multicast group and a multicast path can be effectively updated based on a notification message of belonging to multicast group transmitted from a mobile host.

Embodiment 2

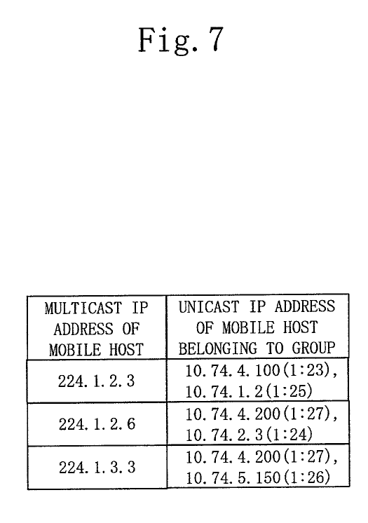

In this Embodiment 2, the case of setting a period of validity of each entry in the multicast group management table 302 will be described. FIG. 7 shows an example of the multicast group management table 302 according to Embodiment 2.

In the above Embodiment 1, the entry in the multicast group management table 302 is deleted based on the control message transmitted from the mobile host when the mobile host leaves the domain 102. However, the entries are not necessarily deleted in the case that the power of the mobile host is suddenly turned off or the control message output from the mobile host has not reached the destination in spite of the mobile host having performed transmission process of the control message.

As shown in FIG. 7, the multicast group management unit 402 sets a period of validity of each entry in the multicast group management table 302. After the period of validity, the entry is automatically deleted. In the case of FIG. 7, the length of the period of validity is temporarily set to be five minutes, and the ending time of the period of validity, which is calculated by adding five minutes to the time when adding or updating of each entry is performed, is registered in the table.

For instance, if the ending time of the validity period is twenty-three minutes past one o'clock, it is registered as (1:23) in FIG. 7. When the mobile host wants to continue to receive a multicast packet, the mobile host broadcasts the notification message of belonging to multicast group again within the period of validity.

Receiving the broadcast of the notification message, each router creates an entry if there is no entry and resets the timer (the ending time of validity period) if the entry already exists. In order to perform this process, the multicast group management unit 402 is expanded. The multicast group management unit 402 also has a function of searching all the entries in the multicast group management table 302 shown in FIG. 7 at every specified time interval (ex. every one minute) and deleting an entry whose period of validity has already passed.

Thus, by dint of setting the period of validity in the multicast group management table 302, it is possible to deal with the omission of entry deletion in the multicast group management table 302 caused by the case that the multicast group withdrawal notification message has not reached. Namely, it is possible to avoid uselessly enlarging the multicast group management table 302. The multicast path table 303 can be effectively created and maintained with respect to the size of the multicast group management table 302.

According to the multicast group management memory in the communications control system of the present Embodiment, a multicast group can be managed by using a validity period which has been set.

Embodiment 3

In Embodiment 3, it will be described the case the control message of mobility management protocol which manages the unicast path table 301 includes the contents of control message for managing the multicast group management table 302.

In the above Embodiment 2, the period of validity is set for each entry in the multicast group management table 302. Therefore, when it is needed to keep belonging to the multicast group, the notification message of belonging to the multicast group has to be transmitted again within the validity period. This increases the times of transmitting the message to be more than the times of transmitting the message in Embodiment 1, which has a disadvantage not only in the respect of traffic but also in the respect of power consumption. Because mobile hosts are often operated by battery, much power is consumed in the case of Embodiment 2.

As stated in Embodiment 1, broadcasting can be easily realized by way of transmitting a message to the domain gateway 101 first and broadcasting the message from the domain gateway 101. Therefore, in this case of the mobile host broadcasting the notification message of belonging to multicast group can also be realized by way of transmitting the message to the domain gateway 101 first and broadcasting the message from the domain gateway 101.

On the other hand, in the mobility management protocol managed by an entry of path specified by a host (host address) designation, such as IP Cellular, the control message is finally transmitted to the domain gateway 101. Otherwise, when a packet has reached the domain gateway 101 from the outside of the domain, it is not clear for the domain gateway 101 where to transfer the packet.

The control message of mobility management protocol for unicast path is generated and transmitted by the unicast path control unit 401 of the mobile host.

It is assumed that the control message of mobility management protocol for unicast path is transmitted when the mobile host transfers to another base station area, or when a validity period is re-updated within the period of validity in the unicast path control unit 401. In this case, the period of validity for the combination of a unicast IP address and an output destination interface stored in the unicast path table 301 is defined to be “validity period (1)”, and the control message of mobility management protocol for unicast path is defined to be “first control message”.

It is set, as a schedule (1), to transmit the control message of mobility management protocol for unicast path (the first control message) again when a time period a little shorter than the validity period (1) has passed after the control message of mobility management protocol for unicast path having been transmitted. The time period a little shorter than the validity period (1) indicates, for instance, 80% of the validity period.

The control message for managing the multicast group management table 302 is generated and transmitted by the multicast group management unit 402 of the mobile host. A validity period is set for belonging to a multicast group based on the control message for managing the multicast group management table 302. Therefore, it is possible to transmit the control message again within this validity period, if necessary. In this case, the validity period is defined to be “validity period (2)” for a combination of a multicast IP address and a unicast IP address belonging to the group of the multicast IP address stored in the multicast group management table 302, and the control message for managing the multicast group management table 302 is defined to be “second control message”.

In order to manage the period of validity, the multicast group management unit 402 stores the latest time of transmitting the control message for managing the multicast group management table 302 (the second control message) and the validity period (2). In the multicast group management unit 402, a schedule (2) is set to transmit the second control message again when a time period a little shorter than the validity period (2) has passed after the second control message having been transmitted.

When the unicast path control unit 401 transmits the control message of mobility management protocol for unicast path (the first control message), the unicast path control unit 401 inquires the multicast group management unit 402 whether or not to include the control message for managing the multicast group management table 302 in the control message of mobility management protocol for unicast path.

At this time, the unicast path control unit 401 informs the multicast path control unit 403 of a next scheduled time (the current time+the validity period (1)) of transmitting the control message of mobility management protocol for unicast path (the first control message).

After being inquired, the multicast group management unit 402 compares the next scheduled time of transmitting the first control message with the next scheduled time of transmitting the second control message. Concretely, the next scheduled time of transmitting the second control message indicates the time: the latest time of transmitting the second control message+the validity period (2). If the next scheduled time of transmitting the first control message is behind the next scheduled time of transmitting the second control message, the multicast group management unit 402 responds to the unicast path control unit 401 that the second control message (the control message for managing the multicast group management table 302) should be included in the message to be transmitted. In this response, the contents of the second control message is included.

Then, the multicast group management unit 402 stores the current time as the latest time of transmitting the control message for managing the multicast group management table 302, and performs setting the schedule (2) again.

Receiving YES as a response to the inquiry, the unicast path control unit 401 attaches the contents of the second control message generated and sent by the multicast group management unit 402 to the first control message generated by the unicast path control unit 401 itself, and transmits the first control message including the contents of the second control message. Receiving NO, the unicast path control unit 401 transmits the first control message which has been intact. Then, the unicast path control unit 401 performs setting the schedule (1) again.

The control message is generated by the procedures described above. Regarding the transmission of the control message, the unicast path control unit 401 or the multicast group management unit 402 performs own part of the transmission procedure as stated below. The unicast path control unit 401 generates the first control message (the control message of mobility management protocol for unicast path) including the second control message (the control message for managing the multicast group management table 302).

Generation and transmission of the first control message (the control message of mobility management protocol for unicast path) is repeatedly performed at either timing: when the mobile host transfers to another base station area or when 80% of the validity period has passed. This timing corresponds to the timing of the unicast path control unit 401 notifying the multicast group management unit 402 of transmitting the control message.

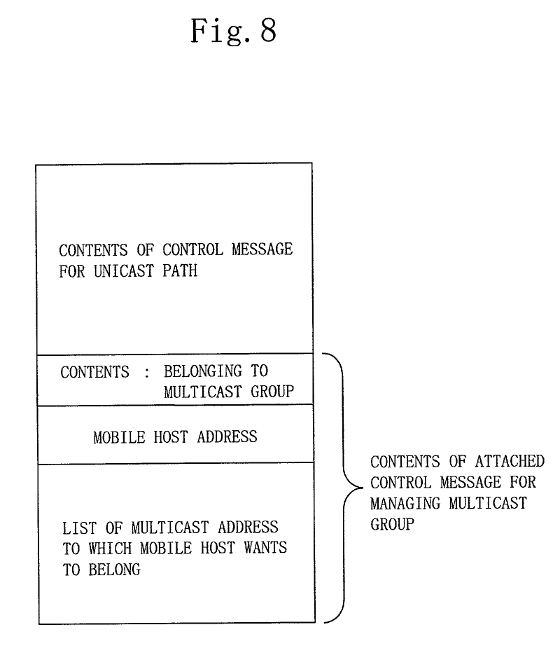

The procedure is not limited to the above, but it is also acceptable to have the following procedure. The unicast path control unit 401 generates the first control message (the control message of mobility management protocol for unicast path). Then, the unicast path control unit 401 requests the multicast group management unit 402 to transmit the first control message. When the multicast group management unit 402 transmits the control message to the domain gateway 101, if necessary, the control message for managing the multicast group management table 302 can be included in the control message of mobility management protocol for unicast path as shown in FIG. 8. Whether the control message for managing the multicast group management table 302 is included in the control message of mobility management protocol for unicast path or not, it is supposed that the control message is finally sent to the domain gateway 101.

By dint of the above, the times of transmitting the control message can be reduced. A common part to every message, such as an IP header in the case of the control message being an IP packet, can be omitted. Therefore, it is possible to lessen the total message size. The control messages separately output from the unicast path control unit 401 and the multicast group management unit 402 can be combined to be one control message. Thus, not only the traffic but also the power consumption can be reduced.

According to the communications control system of the present Embodiment, control messages to be forwarded can be reduced.

Embodiment 4

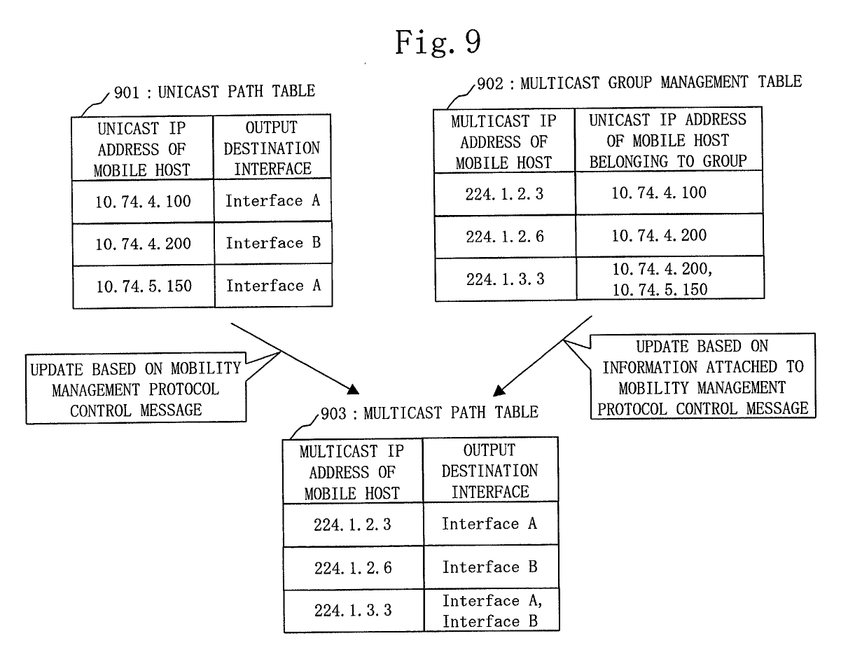

An example of generating a multicast path table according to Embodiment 4 will now be explained with reference to FIG. 9. A unicast path table 901 corresponds to the unicast path table 301 in FIG. 3 and a multicast path table 903 corresponds to the multicast path table 303 in FIG. 3. The form of a multicast group management table 902 is the same as the multicast group management table 302 in FIG. 3, but the size of the contents of the table 902 is smaller than the table 302. Namely, the unicast IP addresses 10. 74. 1. 2, and 10. 74. 2. 3 are not registered. The common feature of these unicast IP addresses is that their addresses are not registered in the unicast path table 901. In Embodiment 1, the control message for creating/managing the multicast group management table is broadcast in the domain and the same control message is used at each router in the domain. In this Embodiment 4, the control messages used at routers in the domain are not the same.

In Embodiment 3, it has been described that the control message for managing the multicast group management table can be included in the control message of mobility management protocol for unicast path, which controls paths for the mobile host by managing an entry of path specified by a host designation. In Embodiment 3, information for managing the multicast group management table is transmitted to the domain gateway 101 and broadcast from the domain gateway 101.

However, information of mobile host which is not related to a router is included in the multicast group management table 302. For instance, the unicast addresses 10. 74. 1. 2, and 10. 74. 2. 3 are registered in the table 302 but are not registered in the multicast group management table 902. This means that a packet addressed to a unicast address which is not registered in the unicast path table 901 is not necessary to be delivered to routers and base stations lower than the router where the packet has reached. (Usually, as shown in the path table of FIG. 2, the packet is transmitted to the default path.) In this case, it indicates that a mobile host having an address to which the packet is addressed does not exist in the area lower than the router. Namely, the information of mobile host is not related to the router.

Then, information necessary for managing the multicast group management table 902, that is the mobile host address and one or more than one address of multicast to which the mobile host belongs, is attached to the control message of mobility management protocol for unicast path table. Whether the control message for managing the multicast group management table is included in the control message of mobility management protocol for unicast path or not, the control message is supposed to be finally sent to the domain gateway 101 in the same way as Embodiment 3.

At the router which received the control message, not only the unicast path table 901 but also the multicast group management table 902 is managed based on the algorithm of the mobility management protocol. The way of managing the multicast group management table 902 is the same as Embodiment 1. Namely, when a notification message of belonging to multicast group is received, an entry is added. Regarding the deletion of the entry, it is acceptable to transmit the control message of withdrawing from multicast group as described in Embodiment 1, or it is also acceptable to delete the entry at the ending time of the validity period as described in Embodiment 2. If a period of validity is also set for the entry in the unicast path table, it is also acceptable to delete the entry at the ending time of this validity period.

According to the present Embodiment 4, the way of creating the multicast path table 903 of FIG. 9 which is necessary for routing a multicast packet is the same as Embodiment 1. The unicast path table 901 is updated based a control protocol for unicast path regardless of the multicast. The unicast path control protocol prescribes a format of unicast path control message and so on.

The multicast group management table 902 is structured based on information attached to the control message of unicast path control protocol. The multicast path table 903 is created by calculation based on the unicast path table 901 and the multicast group management table 902. Since the way of creating the table 903 is the same as Embodiment 1, explanation for it is omitted. The control message necessary for only creating the multicast path table can be obtained by attaching necessary information to the unicast path control message. Therefore, the multicast path table can be effectively created with respect to traffic of the control message. In addition, since the unicast control message is utilized, it is possible to maintain the multicast path table which corresponds and adapts to the mobility. Comparing with Embodiment 1, as the size of the multicast group management table according to Embodiment 4 is small, the multicast path table can be effectively created with respect to the memory utility.

As stated above, the communications control system according to Embodiment 4 has the following features: the unicast path control for the mobile host is performed by inserting/deleting a path for each host in/from the unicast path table 301. The control message of mobility management protocol for managing the unicast path table 901 includes the contents for managing the multicast group management table 902. The multicast path table 903 is created based on the unicast path table 901 and the multicast group management table 902.

Embodiment 5

In Embodiment 5, it will be explained how to create the unicast path table by using a mobility management protocol (communications control protocol) different from the one used in Embodiments 1 through 4. Concretely, the case of the unicast path table not storing a unicast address of mobile host and an output destination interface, for instance the case of applying a communications control protocol, such as Mobile IP, is now explained.

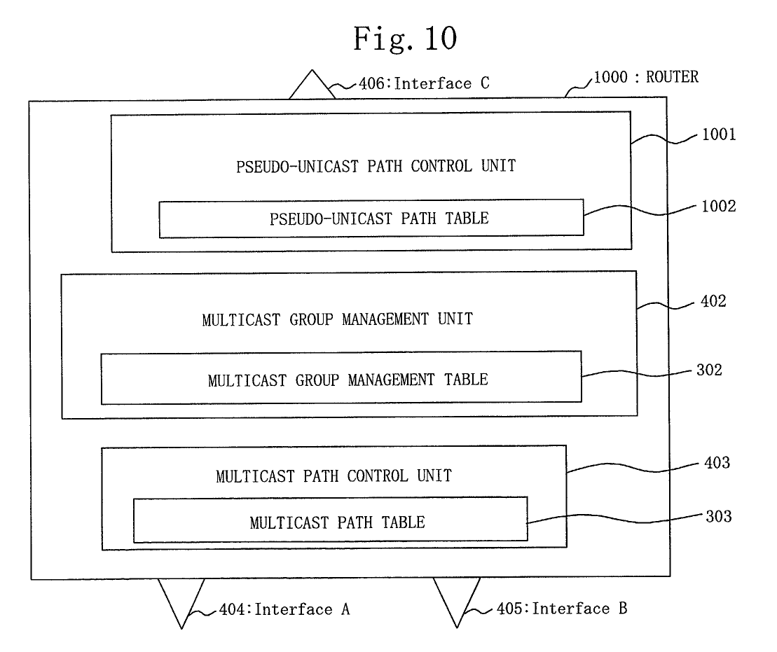

FIG. 10 shows a configuration example of a router 1000 according to Embodiment 5. The router 1000 has a configuration slightly different from the router 400 of FIG. 4. A pseudo-unicast path table 1002 and a pseudo-unicast path control unit 1001 are provided instead of the unicast path table 301 and the unicast path control unit 401.

The difference between the unicast path tables of Embodiment 1 and Embodiment 5 will now be explained. In the unicast path table 301 of Embodiment 1, information relating to a combination of a mobile host address and an output destination interface, to which a packet addressed to the mobile host address is transferred, is important for creating the multicast path table 303. The unicast path control unit 401 manages the mobility by inserting/deleting a path for each host in/from the unicast path table 301.

Meanwhile, there is another mobility management protocol, such as Mobile IP, which utilizes an entry of path for each general network address, not for each host, in order to decide an output destination interface to which a packet addressed to the host is to be transferred. Namely, Mobile IP has a homeaddress which is host's own address. The network where homeaddresses exist is called a home network. When a host leaves the home network and goes into a network called a foreign network, another address called a CoA, which is different from the homeaddress, is obtained. The address CoA can be reached by the routing utilizing a path entry for general network address, not a path entry for each host.

For instance, in the network of FIG. 1, it is supposed that the domain gateway 101 is a home agent for managing the home network, and the mobile host dynamically obtains a CoA whenever the mobile host transfers to the communication area of base stations BS1 through BS8. For instance, it is supposed that the homeaddress of the mobile host MH1 is 2. 3. 4. 1, the base station BS1 is located in the network specified by the network address 1. 1. 1. 0, the base station BS2 is located in the network specified by the network address 1. 1. 2. 0, and the base station BS8 is located in the network specified by the network address 1. 1. 8. 0. When it becomes possible for the mobile host MH1 to have communications with the base station BS1, the mobile host MH1 obtains 1. 1. 1. 100 as a CoA, based on the Mobile IP prescription. When it becomes possible to have communications with the base station BS2, the mobile host obtains 1. 1. 2. 95 as a CoA. Obtaining the CoA, the mobile host MH1 transmits a control message concerning the CoA to the domain gateway 101 which is a home agent.

In Mobile IP, the control message is called a binding update message. The binding update message includes at least the mobile host MH1's homeaddress 2. 3. 4. 1 and CoA 1. 1. 1. 100, for instance. In the domain gateway 101, receiving a packet addressed to the mobile host MH1's homeaddress 2. 3. 4. 1, the packet is transmitted to CoA 1. 1. 1. 100 through a technology called tunneling. The address 1. 1. 1. 100 is included in the network address of 1. 1. 1. 0. and is routed to the network where the base station BS1 exists. Therefore, the packet can be reached the mobile host MH1 in the network of 1. 1. 1. 0.

Since the communications control protocol of the present Embodiment 5 applies the mobility management protocol not utilizing a path entry for each host, it is necessary to provide a new unit for performing functions instead of the unicast path table 301 and the unicast path control unit 401. Then, the case of using a router having the pseudo-unicast path table 1002 and the pseudo-unicast path control unit 1001 will now be explained.

In Embodiment 5, the pseudo-unicast path table 1002 is used instead of the unicast path table 301. The form of the pseudo-unicast path table 1002 is the same as that of the unicast path table 301 of FIG. 3. Instead of the unicast path control unit 401, the pseudo-unicast path control unit 1001 manages the pseudo-unicast path table 1002. Therefore, the multicast path table 303 can be created by the same way as Embodiment 1.

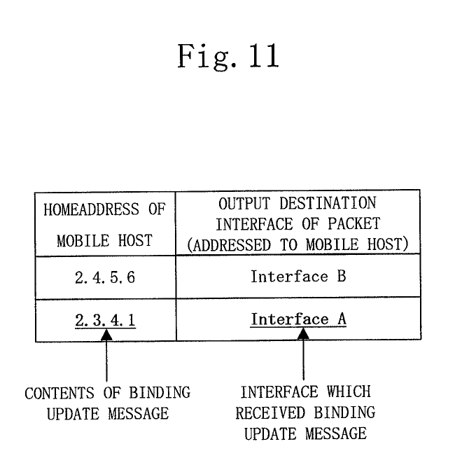

The way of updating the pseudo-unicast path table 1002 by using the pseudo-unicast path control unit 1001 will now be explained with reference to FIG. 11 as an example.

Receiving or transferring a control message of notifying a mobile host's location (address), such as a binding update message of Mobile IP, the router 1000 refers to the contents of the control message. This message includes at least the mobile host's homeaddress and the current address (CoA).

Supposing a binding update message is referred, it found out that the message relates to a host of homeaddress 2. 3. 4. 1 as shown in FIG. 11, for instance. If the binding update message is received from the network interface A404, it is found out that the host can be reached through the interface A404. Then, the combination of 2. 3. 4. 1 and the interface A is added to the pseudo-unicast path table 1002. As the binding update message is transmitted at a specific interval in Mobile IP case, the pseudo-unicast path table 1002 is updated in accordance with the message transmission. However, a router located on the way to the destination, such as the router 1000, is not notified that the old binding update message is unnecessary. Therefore, a period of validity is set for each entry in the pseudo-unicast path table 1002 and the binding update message is deleted after the period of validity has passed.

By referring to the binding update message, the homeaddress 2. 3. 4. 1 and the current address (CoA), for instance 1. 1. 1. 100, can be obtained. Then, by referring the ordinary path table as shown in FIG. 2 based on these addresses, a network interface, to which the packet is to be output in order to reach 1. 1. 1. 100, can be obtained. The combination of the homeaddress and the network interface can be added to the pseudo-unicast path table 1002. As stated above, the multicast path table necessary for routing a multicast packet can be created.

The pseudo-unicast path table 1002 is updated by the pseudo-unicast path control unit 1001 which refers to control message, such as Mobile IP, regardless of multicast. It is possible to structure the multicast group management table 302 by broadcasting information relating to the mobile host's entering/leaving the domain only when the mobile host enters/leaves the domain. The multicast path table 303 is able to be created by calculation based on the pseudo-unicast path table 1002 and the multicast group management table 302. Since the control message only necessary for creating the multicast path table is the broadcast at the time of the mobile host's entering/leaving the domain, the multicast path table can be effectively created with respect to traffic of the control message.

Though the pseudo-unicast path table 1002 and the pseudo-unicast path control unit 1001 are used for the explanation in Embodiment 5, it is not limited to them. Anyhow, it is necessary for the unicast path control unit 401 to have the following functions.

The unicast path control unit 401 receives a unicast path control message, such as a binding update message, notifying the unicast path change including a destination address, through a network interface. Then, the unicast path control unit 401 obtains the destination address and detects an output destination interface, based on the received unicast path control message. For instance, the network interface which received the unicast path control message is defined to be the output destination interface. The obtained destination address and the detected output destination interface are stored in the unicast path table 301 to be corresponding each other. By dint of the unicast path control unit 401 being provided, the communications control system according to Embodiment 5 can be realized.

As stated above, the communications control system according to Embodiment 5 has the following features. In spite of the mobile host mobility, a fixed address which is fixed to the mobile host can be retained and another address corresponding to the network, to which the mobile host transfers, can also be obtained. The control message including the fixed address and the transfer destination address (the address corresponding to network to which the mobile host transfers) is transmitted to a specified host. At the router located between the mobile host and the specified host, the contents of the control message is referred in order to manage a combination of the mobile host and the network interface to which a packet addressed to the mobile host is to be transferred. Then, this procedure is used instead of the unicast path table. Besides, in this communications control system, the network interface which receives the control message is defined to be a network interface to which the packet addressed to the mobile host is to be transferred.

According to the unicast path control unit in the communications control system of the present Embodiment, an output destination interface can be detected based on a received unicast path control message.

Embodiment 6.

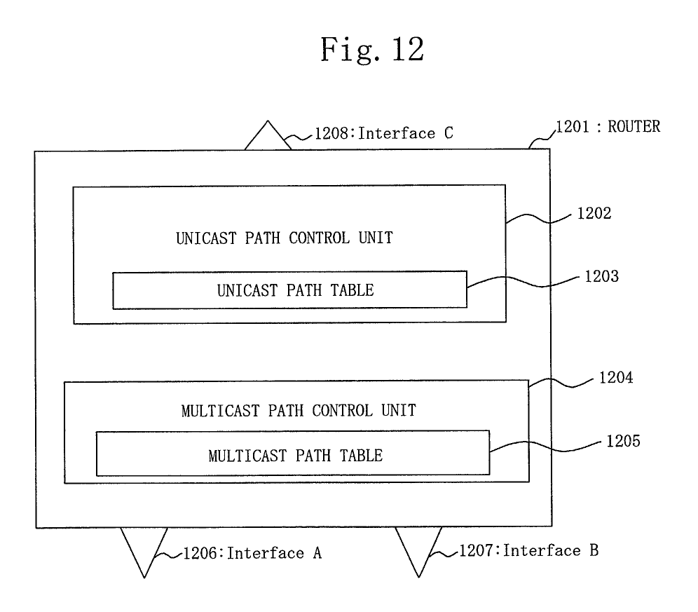

In Embodiment 6, the case of updating the multicast path table based the notification message of belonging to multicast group will now be explained. FIG. 1 shows one configuration example of network where the present Embodiment as well as Embodiment 1 can be applied. FIG. 12 shows a configuration example of a router 1201 according to Embodiment 6. The router 1201 in the hierarchical structure network as shown in FIG. 1 has network interfaces (output destination interfaces) A1206 and B1207 for having communications with lower routers or hosts, and a network interface (output destination interface) C1208 for having communications with an upper router or a domain gateway.

Usually, the router 1201 performs some control of unicast path, with using a unicast path table (unicast path memory) 1203 which is the same as the unicast path table of FIG. 2, and a unicast path control unit (unicast path controller) 1202 for managing the unicast path table 1203. A multicast path table (multicast path memory) 1205 and a multicast path control unit (multicast path controller) 1204 for managing the multicast path table 1205 are also provided in the router 1201.

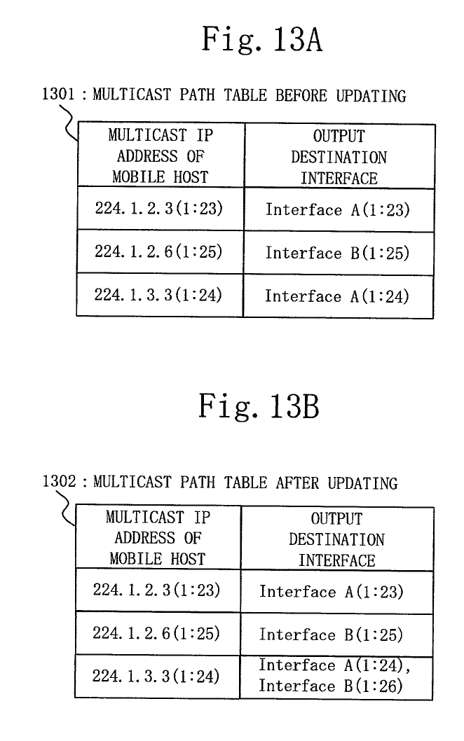

In the multicast path table 1205, a combination of a multicast address and a network interface to which a packet addressed to the multicast packet address is to be transferred, are registered. A multicast path table 1301 before updating of FIG. 13A shows an example of the multicast path table, in which it is represented that a multicast packet addressed to 224. 1. 2. 3 should be output to the interface A as an output destination interface. The time written in the parentheses in FIGS. 13A and 13B will be explained later.

It is supposed that, in the network of FIG. 1 for instance, the mobile host MH1 transfers to the area covered by the domain 102 and can have communications with the base station BS1. The base station BS1 obtains a list of multicast addresses, each of which the mobile host MH1 wants to receive, based on a protocol such as IGMP. Otherwise, the mobile host MH1 directly transmits the list of multicast addresses, each of which the mobile host MH1 wants to receive, to the base station BS1.

For instance, if the mobile host MH1 wants to receive the multicast address 224. 1. 3. 3, the base station BS1 transmits a notification message of belonging to the multicast group which includes the multicast address 224. 1. 3. 3, to the domain gateway 101. This notification message of belonging to the multicast group is referred by a router located on the way to the destination.

The router R21 receives the notification message of belonging to the multicast group from the network interface of interface A1206 in FIG. 12, for instance. The combination of the multicast address 224. 1. 3. 3 and the interface A1206 is added to the multicast path table 1205. This state is shown in the multicast path table 1301 before updating of FIG. 13A. Then, the router R21 transfers the notification message of belonging to the multicast group to the upper router R11 closer to the domain gateway 101. The router R11 performs the same processing as described above and transfers the notification message to the domain gateway 101. The domain gateway 101, as a router, performs the same processing as described above. It is not necessary for the domain gateway 101 to further transfer the notification message.

Next, supposing it becomes possible for the mobile host MH1 to have communications with the base station BS2, the base station BS2 gets the information that the mobile host MH1 wants to receive a packet addressed to the multicast address 224. 1. 3. 3, and transmits the control message (notification message) toward the domain gateway 101. This message is transferred to the router R21 through the same procedures as described above, from the network interface of interface B in FIG. 12. Then, the combination of the address 224. 1. 3. 3 and the interface B is added to the multicast path table 1205. This state is shown in the multicast path table 1302 after updating of FIG. 13B.

If a multicast group is managed at each base station based on IGMP or a protocol corresponding to IGMP, the each base station can judge which packet addressed to multicast address is to be transferred by wireless. Therefore, when the mobile host MH1 transfers to the area covered by the base station BS2 from the area by the base station BS1, and when there is no host which wants to receive a packet addressed to multicast address 224. 1. 3. 3 in the area covered by the base station BS1, the base station BS1 will find that it is unnecessary to transfer the packet addressed to multicast address 224. 1. 3. 3.

The information that transferring the packet addressed to multicast address 224. 1. 3. 3. is unnecessary is transmitted to the upper router and the entry relating to the multicast address 224. 1. 3. 3 is deleted from the multicast path table 1205. In this case, if no output destination interface is correspondingly registered for the multicast address 224. 1. 3. 3 in the multicast path table 1205, the control message of deletion is transferred to the upper router. If other output destination interface is correspondingly registered for the multicast address 224. 1. 3. 3, the control message of deletion is not transferred to the upper router.

Namely, the multicast path table 1205 is managed by way of registering a network interface, in which a host requesting to receive a multicast packet exists, in the multicast path table 1205. Then, the multicast communications control corresponding to the mobility of the mobile host can be realized.

Regarding the way of deleting an entry in the multicast path table 1205, the way of setting a validity period for each entry can also be accepted as well as the way of deletion by the control message. After the period of validity has passed, the entry is automatically deleted, which reduces the traffic of control message.

Now, the setting a validity period will be explained. In the multicast path table 1301 of before updating of FIG. 13A, it is supposed that “five minutes” is set for each entry for the combination of the address and the interface as a period of validity. FIG. 13A shows that the ending time of the validity period for the combination of the address 224. 1. 3. 3 and the interface A is 1:24 (that is twenty-four minutes past one o'clock). When the control message of requesting to belong to the address 224. 1. 3. 3 is received from the interface B at 1:21, the multicast path table is updated to be the multicast path table 1302 of after updating of FIG. 13B. Considering the upper router, it can be supposed there is also an entry whose validity period ending time is 1:24 in the multicast path table 1205 of the upper router.

Namely, even if no control message of belonging to the multicast group is transmitted to the upper router, the entry at the upper router will not be deleted for three minutes from the current time 1:21 to the validity period ending time 1:24. Accordingly, it is not necessary to transmit the control message to the upper router at the time when the control message is received from the interface B. If the control message is transmitted within the next period of validity of the interface A, the multicast path table at the upper router can be thoroughly maintained. By dint of controlling the timing of transmitting the notification message to the upper router, the traffic of control message can be reduced.

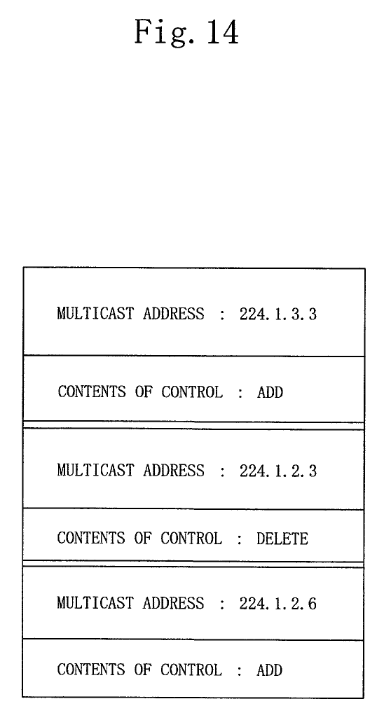

Besides, the traffic of control message can also be reduced by way of collectively transmitting entries of different multicast addresses having the same validity period to the upper router. FIG. 14 shows an example of control message where different multicast addresses having different control messages (multicast path management notification), such as adding or deleting, are collected.

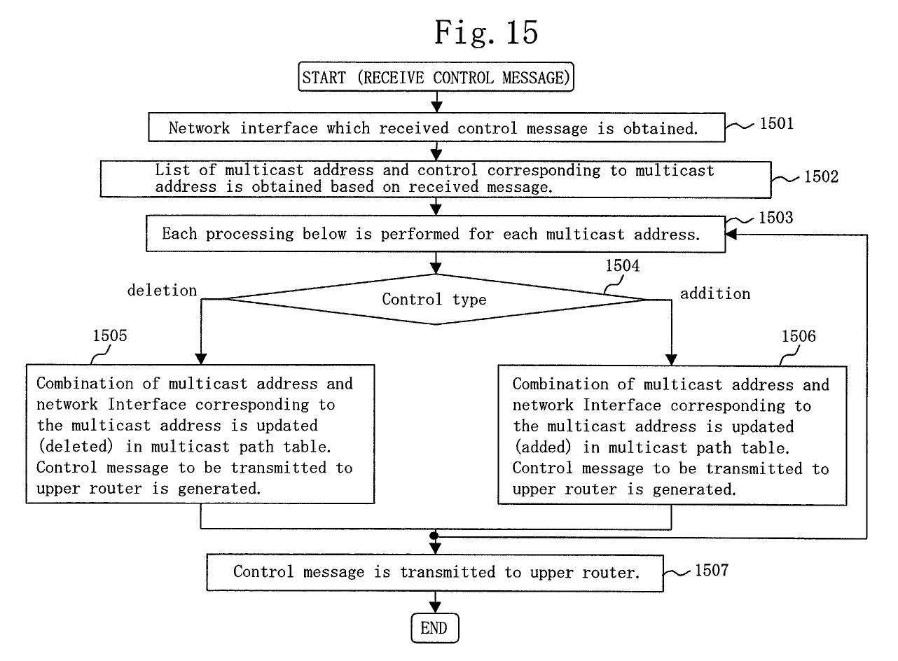

Detailed explanation of operations of the multicast path control unit 1204 (multicast path control step) according to Embodiment 6 will now be described with reference to FIGS. 15, 16, and 17. Receiving the control message (multicast path management notification), such as the adding or deletion message to/from the multicast path table 1205 as shown in FIG. 14, the network interface which received the control message is obtained at 1501. Based on the received control message, a list of multicast addresses and control contents corresponding to the multicast addresses is obtained at 1502. An example of the list is shown in FIG. 14 where the multicast address 224. 1. 3. 3 is added, the multicast address 224. 1. 2. 3. is deleted, and the multicast address 224. 1. 2. 6 is added.

For each combination of the multicast address and the control contents of the multicast path management notification corresponding to the multicast address, processing in accordance with the type (control type) of each control message contents is respectively performed at 1503. During the processing, a control message to be transmitted to the upper router is generated. Then, the generated control message is transmitted to the upper router after each processing for each multicast address having been performed at 1507. If the control message has not been generated, no message is transmitted.

The processing in accordance with the control type of each control message contents will now be explained. In the case of deletion, the combination of the multicast address to be deleted and the network interface corresponding to the multicast address is deleted from the multicast path table 1205. The control message (deletion) to be transmitted to the upper router is generated at 1505. In the case of addition, the combination of the multicast address to be added and the network interface corresponding to the multicast address is added to the multicast path table 1205. The control message (addition) to be transmitted to the upper router is generated at 1506.

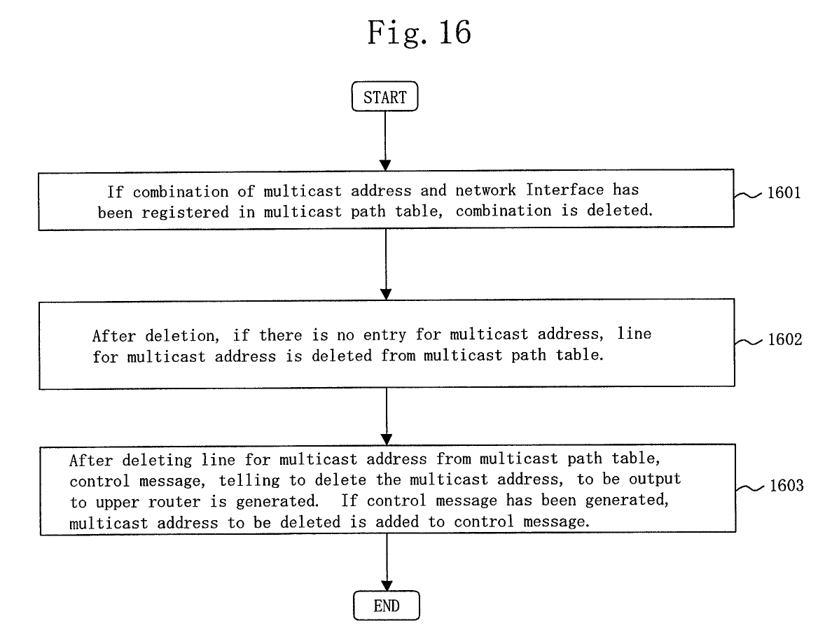

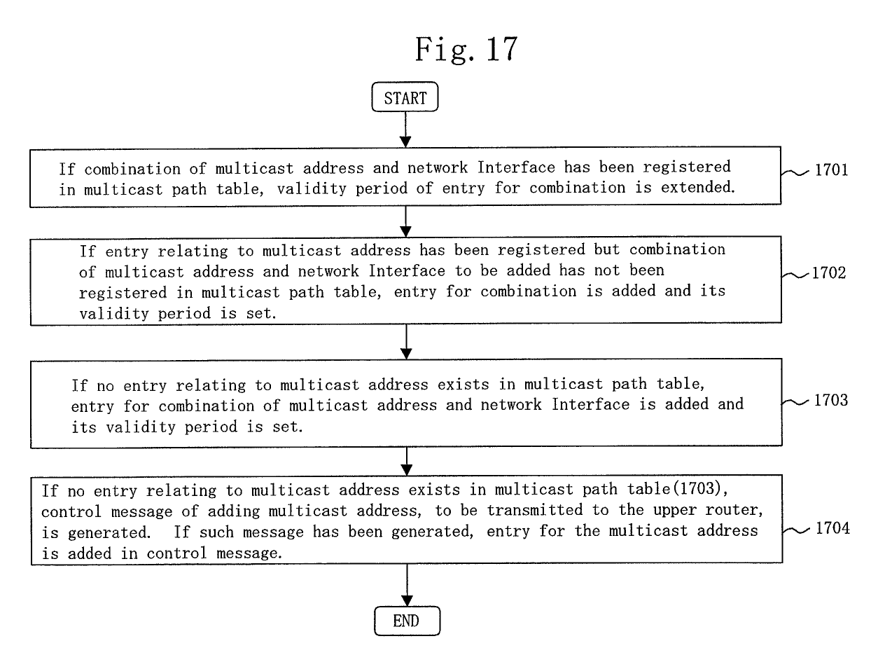

Each processing is further explained with reference to FIGS. 16 and 17. FIG. 16 shows the path deletion processing corresponding to 1505 in FIG. 15. In the case that a combination of the multicast address and the network interface to be deleted has been already registered in the multicast path table 1205, the combination is deleted at 1601. If the deleted entry was only one entry for the multicast address, no entry for the multicast address now exists in the multicast path table 1205. Namely, it is no longer necessary to transmit a packet addressed to the multicast address to this router.

Therefore, at 1602, the line for the multicast address is deleted from the multicast path table 1205, and a control message telling to delete the multicast address is generated to be output to the upper router. If a control message has been already generated, this control message telling to delete the multicast address is added to the control message to be transmitted to the router at 1603. This control message has the form shown in FIG. 14.

FIG. 17 shows the path addition processing corresponding to 1506 in FIG. 15. If a combination of the multicast address and the network interface to be added has been already registered in the multicast path table 1205, the validity period of the entry for the combination is extended at 1701. If an entry relating to the multicast address has been already registered, but a combination of the multicast address and the network interface has not been registered in the multicast path table 1205, the entry for the combination is added and its validity period is set at 1702.

In the case that the entry relating to the multicast address has been already registered, a check of validity period and a transmission of the message to the upper router (stated later) are periodically performed. Therefore, the message of adding the entry for the combination of the multicast address and the network interface will be transmitted to the upper router.

If no entry relating to the multicast address exists in the multicast path table 1205, the entry for the combination of the multicast address and the network interface is added and its validity period is set at 1703. In this case, since the multicast address is for the first time requested to be transmitted, the control message of adding the multicast address is generated at 1704 to be transmitted to the upper router.

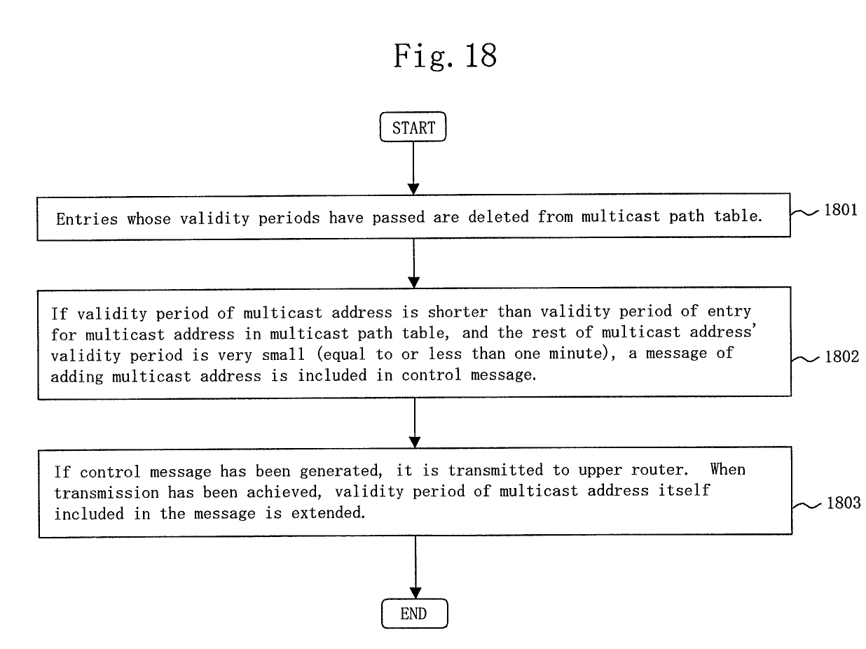

The periodic processing of checking the validity period of each entry in the multicast path table 1205 and the generating/transmitting of the control message to the upper router will now be explained with reference to FIG. 18.

It is supposed that the periodic processing is performed every one minute. All the entries in the multicast path table 1205 are detected and entries whose validity periods have passed are deleted at 1801. This deletion processing is the same as that shown in FIG. 16. If necessary, the control message to be transmitted to the upper router is generated.

If a validity period of a multicast address itself is shorter than any validity period of entry relating to the multicast address in the multicast path table 1205, and if the rest of the multicast address' validity period is very small such as equal to or less than one minute, a message of adding the multicast address is included in the control message at 1802.

By dint of this procedure, it is possible to gather added messages relating to a multicast address together based on the multicast address itself as a unit, not based on the entry for the multicast address as a unit, in order to transmit the messages to the upper router. The time limit of validity period of multicast address itself indicates a deadline for transmitting the control message to the upper router. After processing of the control message (that is, deletion or addition) having been performed, if the control message has been already generated, the control message is transmitted to the upper router. Then, the validity period of the multicast address itself included in the transmitted message is extended at 1803.

Detailed operation of FIG. 18 will now be explained with reference to the multicast path table in FIGS. 13A and 13B. In the multicast path table 1301 before updating of FIG. 13A, the interface A is registered to be corresponding to the multicast address 224. 1. 3. 3. On the other hand, in the multicast path table 1302 after updating of FIG. 13B, the interface B is also registered to be corresponding to the multicast address 224. 1. 3. 3. This may be the case there are mobile hosts, each of which wants to receive a packet addressed to the same multicast address, at the location lower than the interface A and at the location lower than the interface B.

The operation of FIG. 18 indicates that the control message requesting to transmit the multicast packet addressed to 224. 1. 3. 3 is transmitted to the upper router at the timing of the interface A being added (updated). However, regarding the interface B, the control message is not transmitted to the upper router at the timing of the interface B being added. The reason is that the time of adding the interface A and transmitting the control message to the upper router is 1:24 but the time of adding the interface B is 1:26. Since the period of validity is five minutes, it is judged that there is still more time (three more minutes) before the time limit of validity period of the interface A.

Concretely, the validity period (validity period ending time) of multicast address itself in the multicast path table 1205 is 1:29, which is calculated by adding five minutes to the time 1:24 (in the left side of the multicast path table 1302 after updating) of transmitting the notification message to the upper router of the address 224. 1. 3. 3. The validity period of the entry relating to the multicast address (that is, relating to a combination of the multicast address and the output interface) can be calculated by adding five minutes to 1:24 or 1:26 on the right side of the multicast path table 1302 after updating. (1:24+5 minutes=1:29, 1:26+5 minutes=1:31).

According to 1802 of FIG. 18, though 1:24+5 minutes is shorter than 1:26+5 minutes, the rest of the validity period is not small (not less than one minute), because the current time is 1:26 and the ending time of the validity period is 1:24+5 minutes (1:29). Therefore, the control message to be transmitted to the upper router is not generated.

The validity period of multicast address itself regulates the timing of transmitting a notification message to the upper router, whereas the validity period of entry relating to multicast address regulates the timing of deleting a registration, which is requested by the lower router. At 1802 of FIG. 18, when a plurality of network interfaces are provided for a lower router, there may be different timings of transmitting a notification message (control message) to the upper router. Therefore, the notification messages to the upper router are gathered to be transmitted at one timing, and this timing is predefined.

As stated above, the communications control system according to Embodiment 6 has the following features: the multicast path table 1205, which manages a combination of a multicast address and a network interface to which a packet addressed to the multicast address is transferred, is used. When the multicast path control unit 1204 receives a notification message of belonging to multicast group, including the multicast address to which the packet is to be transferred, the multicast path control unit 1204 adds the combination of the multicast address and the network interface which received the message to the multicast path table 1205. The multicast path control unit 1204 transfers the notification message of belonging to multicast group to the gateway for connecting with an external network.

According to the communications control system of Embodiment 6, in the case of a plurality of network interfaces being correspondingly registered for a multicast address in the multicast path table 1205, control messages to the upper router are gathered together to be transmitted at one timing, based on the consideration of validity periods of the multicast address and the network interface. Regarding a plurality of multicast addresses, if their validity periods are the same or close to each other, their control messages to the upper router are gathered together to be transmitted at one timing.

According to the communications control system of Embodiment 6, in the case of a control message based on a unicast path control being transmitted toward the domain gateway 101 as described in Embodiment 4, a multicast path management notification is included in the unicast path control message. Therefore, the traffic can be reduced.

In the communications control system of Embodiment 6, where an entry relating to a path for each host is added or deleted in the unicast path table in order to perform a unicast path control for a host, the contents of managing the multicast path table 1205 (multicast path management notification) is included in the control message.

In the communications control system of Embodiment 6, a fixed address is retained in spite of the mobility, another address corresponding to the network to which the mobile host transfers is also obtained, and the mobility is managed by transmitting a control message, including the fixed address and the address corresponding to the network, to a specific host. The contents of managing the multicast path table 1205 (multicast path management notification) is included in the control message.

According to the communications control system of the present Embodiment, a multicast path can be updated based on a notification message of belonging to multicast group.

According to the communications control system of the present Embodiment, a multicast path in the network composed of a gateway and a plurality of routers can be updated by forwarding a notification message of belonging to multicast group to the gateway.

According to the multicast path memory in the communications control system of the present Embodiment, a multicast path can be managed by using a validity period which has been set.

According to the multicast path control unit in the communications control system of the present Embodiment, a multicast path can be managed, such as added or deleted, based on a multicast path management notification.

According to the communications control system of the present Embodiment, a multicast path can be effectively updated based a notification message of belonging to multicast group transmitted from a mobile host.

According to the communications control system of the present Embodiment, data in a packet whose multicast address has been set can be effectively forwarded.

Embodiment 7

In this Embodiment, the case of switching data reception will be explained. After having transferred, a mobile host still continues to receive data via the network used before transferring even after transmitting a notification message of belonging to multicast group. Then, when it becomes impossible for the mobile host to receive data via the network used before transferring, the mobile host switches the data reception to receive data via the network where the mobile host has transferred. The configuration of a router used in this Embodiment is the same as one of the routers used in Embodiments 1 through 6.

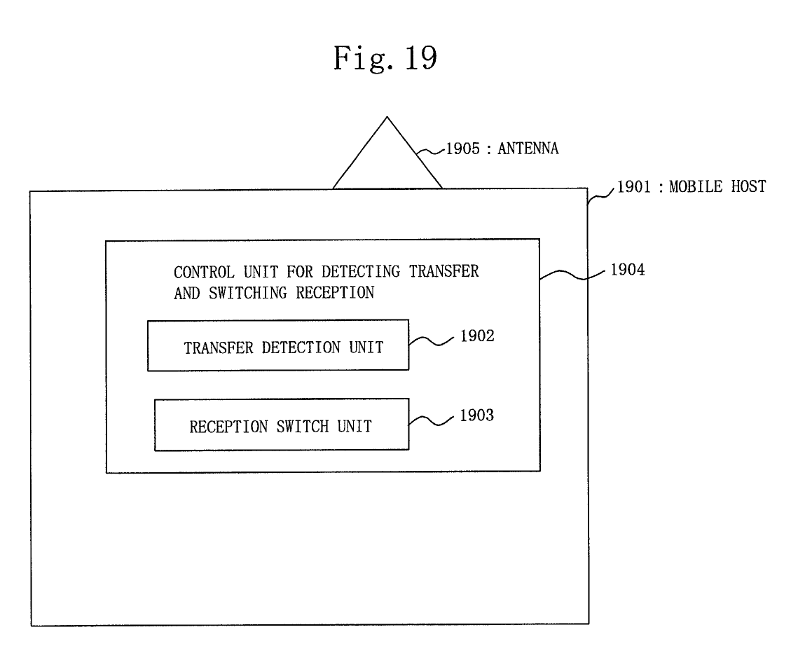

First, the case of transferring between networks will be explained with reference to the configuration example of mobile host used in Embodiment 6. FIG. 19 shows the configuration example of mobile host according to Embodiment 6. In a mobile host 1901, the following is provided: a wireless antenna 1905, a transfer detection unit 1902 for detecting a transfer based on the strength of radio wave from the base station, a reception switch unit 1903 which performs tuning after the transfer in order to receive the radio wave from the base station outputting the strongest wave, and a control unit 1904 for detecting transfer & switching reception which controls the above units.

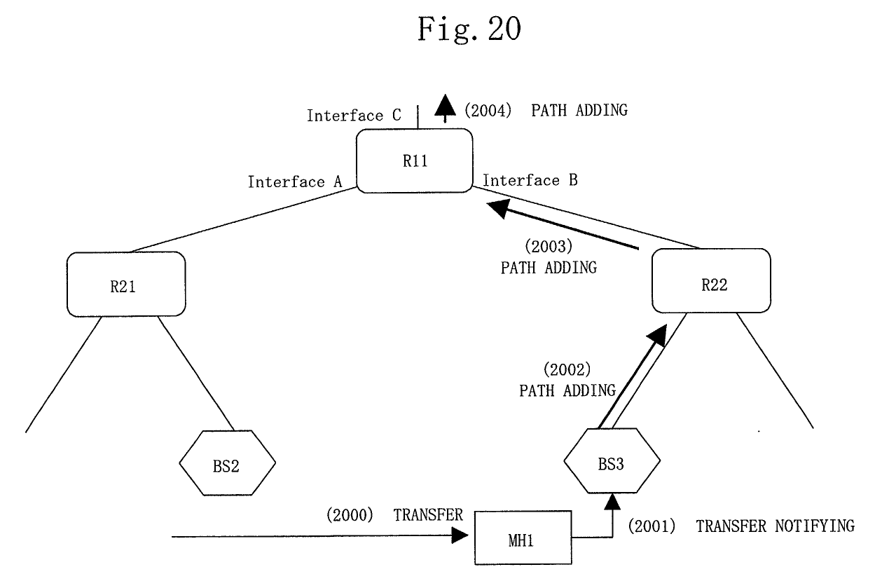

FIG. 20 shows a flow of control message according to Embodiment 6. FIG. 20 is an enlarged part of FIG. 1. R11, R21, R22, BS2, BS3, and MH1 are the same as those of FIG. 1.

At 2000, it is supposed the mobile host MH1 transfers to the area covered by the base station BS3 from the area covered by the base station BS2. By using the transfer detection unit 1902, the mobile host MH1 detects that the base station has changed. Then, the mobile host MH1 begins to receive the radio wave from the base station B3, by using the reception switch unit 1903. These operations are directed by the control unit 1904 for detecting transfer & switching reception. At 2001, the control unit 1904 for detecting transfer & switching reception of the mobile host MH1 transmits a control message including a list of multicast addresses, each of which the mobile host MH1 wants to receive, to the base station BS3.

The base station BS3 transmits the control message to the upper router R22 at 2002. The router R22 updates a multicast path table based on the contents of the control message, and transmits the updated control message to the upper router R11 at 2003. The router R11 further transmits the control message to the upper router at 2004.

After the processing of 2003 having been performed, it is possible to perform routing a multicast packet transmitted from the upper router of the router R11, to the base station BS3. However, if the control message is just being transmitted from the base station BS3 to the router R22 and to the router R11, as the path for the multicast packet has not been established, the routing the multicast packet to the base station BS3 is not performed. Routing the multicast packet should be performed to the base station BS2 which was used before the transfer.

In the case the mobile host MH1 can not have communication with a plurality of base stations at the same time, it is impossible for the mobile host MH1 to receive a multicast packet transmitted from the upper router of the router R11 during the control message being transmitted from the base station BS3 to the router R11. However, regarding the communications areas of the base stations BS2 and BS3, there is a possibility of their communications areas partially being overlapped. In the above case, the advantage of being overlapped is not utilized.

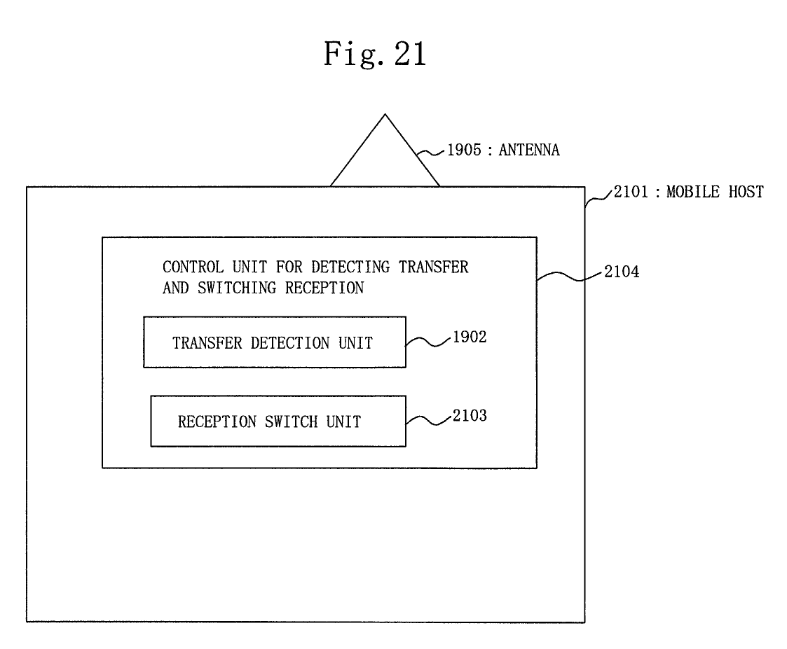

Now, the case of transferring between networks will be explained with reference to the configuration example of mobile host according to Embodiment 7. FIG. 21 shows a configuration example of mobile host used in Embodiment 7. Though the configuration of a mobile host 2101 is the same as that in FIG. 19, functions of a reception switch unit 2103, and a control unit 2104 for detecting transfer & switching reception are different from those in FIG. 19.

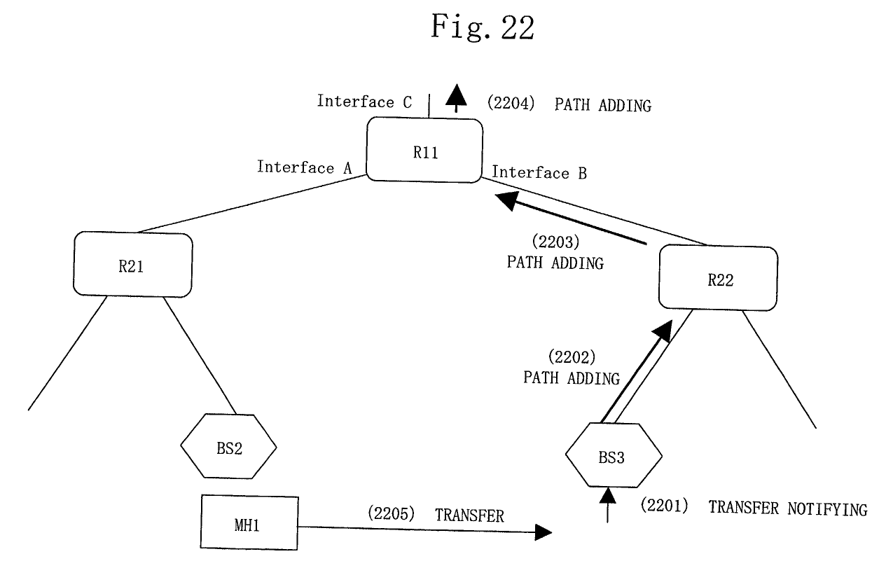

FIG. 22 shows a processing flow according to Embodiment 7. It is supposed the mobile host MH1 knows, by using the transfer detection unit 1902, that the mobile host MH1 has come to an overlapped area where the communications areas of the base station BS2 and the base station BS3 are partially overlapped. Then, at 2201, the control unit 2104 for detecting transfer & switching reception transmits a list of multicast addresses, each of which the mobile host MH1 wants to receive, to the base station BS3 just for a moment. Regarding the list transmission to the base station BS3, if the BS3 broadcasts its own address through a wireless interface for instance, the mobile host MH1 is able to know the address of the base station BS3 and to transmit the list to it.

Based on the control of the control unit 2104 for detecting transfer & switching reception, the reception switch unit 2103 waits for receiving from the base station BS2, without performing any reception switching. During this, the base station BS3 transmits the control message to the router R22 and further to the router R11 in the same way as Embodiment 6. When the transfer detection unit 1902 detects that the mobile host MH1 has come outside of the area covered by the base station BS2, the reception switch unit 2103 switches the receiving from the base station BS2 to the base station BS3.

After the control message having been transmitted to the router R11 and the multicast path table having been updated, the multicast packet is to be transmitted to both the interface A and the interface B of the router R11 until the deletion control message is delivered from the router R21 side. During the control message being delivered from the base station BS3 to the router R11, it may be possible to receive a packet which has not been transmitted to the interface B side of the router R11, at the side of the base station BS2. Therefore, the packet loss can be reduced.

According to the communications control system of the present Embodiment, all the data can be received even in the case that a mobile host transfers between networks.

Embodiment 8

In this Embodiment, the case that a message of finishing path addition is transmitted to the mobile host after the path has been added to the multicast path table will be explained. Receiving this message, the mobile host performs a reception switching to receive data via the network to which the mobile host has transferred. The configuration of the mobile host according to Embodiment 8 is the same as that of FIG. 21, and the configuration of a router used in this Embodiment is the same as one of the routers used in Embodiments 1 through 6.

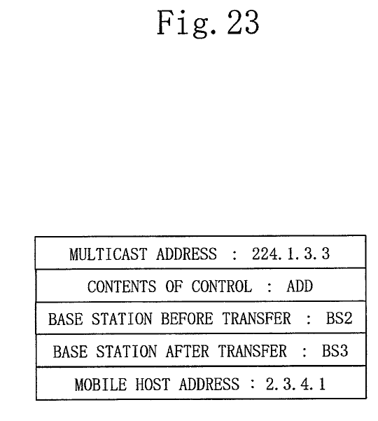

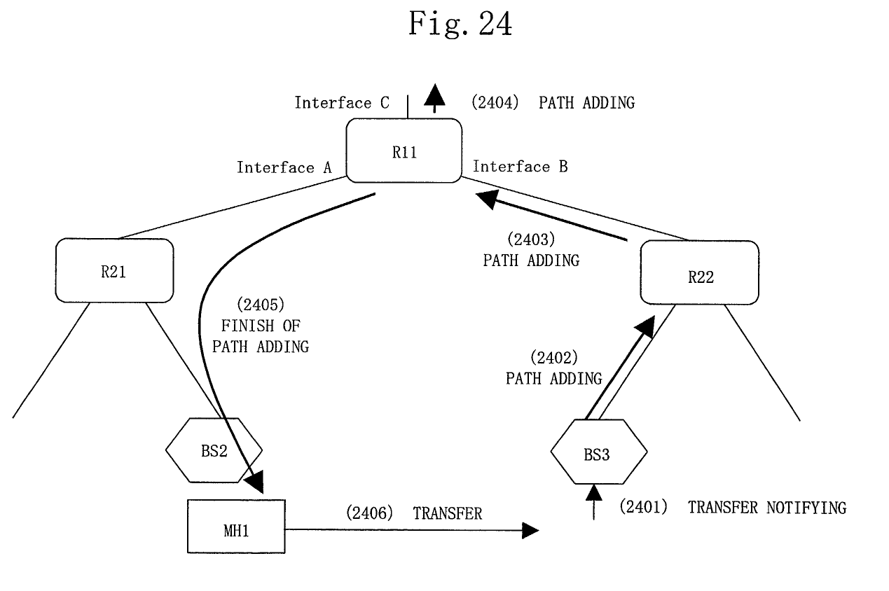

Embodiment 8 is explained with reference to FIGS. 23 and 24. In Embodiment 7, the actual transfer (2205 in FIG. 22) is performed in the state that it is impossible to have communications with the base station BS2. With respect to the timing, however, it would be better to perform the reception switching at the time of the entry for the interface B being added to the multicast path table at the router R11 and the packet, which reached after the entry having been added, having reached the base station BS3.

As shown in FIG. 24, when the router R11 transmits the control message to the upper router at 2404, the router R11 simultaneously transmits a notification that updating the multicast path table has been finished to the mobile host MH1 at 2405. Receiving this notification, the mobile host MH1 performs reception switching to receive from the base station BS3 by using the reception switch unit 2103 at 2406.

Not only the list of multicast addresses but also the address of base station used before transfer is transmitted from the mobile host MH1 to the base station BS3. FIG. 23 shows the contents of the control message to be transmitted to the upper router from the base station BS3. In Embodiment 6, only the multicast address and the contents of control message are included in the control message. In addition to the multicast address and the contents of the control message, the address of mobile host requesting to receive the multicast address, the address of the base station before transfer, and the address of the base station after transfer are included in Embodiment 8.

At the upper router, the updating processing of the multicast path table is performed as stated before. If the network interface for transmitting a packet addressed to the base station used before transfer and the network interface for transmitting a packet addressed to the base station used after transfer are different and both the network interfaces are used for transmitting data to lower routers, a message of finishing entry addition is transmitted to the mobile host after the entry has been added to the multicast path table. The address to which this message is transmitted is included in the message of FIG. 23.

The router R22 in FIG. 24 does not correspond to the above case, because the router R22 uses the upper interface in order to transmit the message to the base station BS2. The router R11 in FIG. 24 corresponds to the above case, because the router R11 uses the interface A in order to transmit the message to the base station BS2 and the interface B in order to transmit the message to the base station BS3. In this way, the packet loss can be reduced.

According to the unicast path control unit in the communications control system of the present Embodiment, a network interface which received a unicast path control message can be regarded as an output destination interface.

Embodiment 9

In this Embodiment, the case of a router existing in the network used before transfer is requested to transmit the message to the network used after transfer will now be explained. The configuration of the mobile host according to Embodiment 9 is the same as that of FIG. 21, and the configuration of the router used in this Embodiment is the same as one of the routers used in Embodiments 1 through 6.

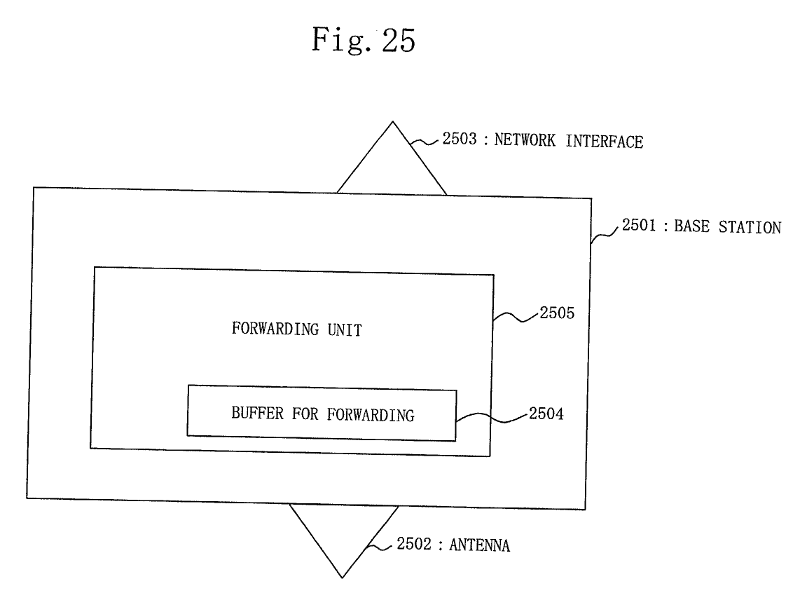

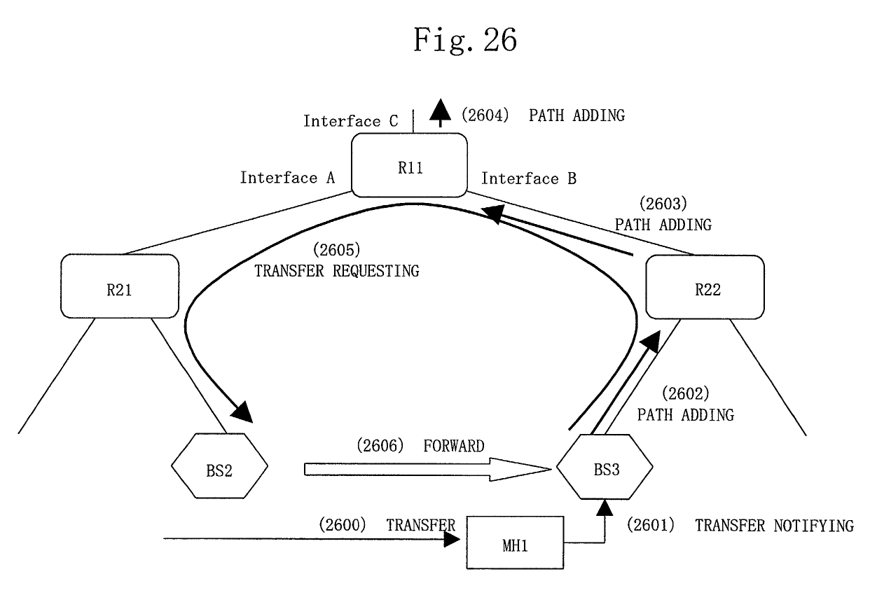

Embodiment 9 is explained with reference to FIGS. 25 and 26. FIG. 25 shows a configuration example of the base station of FIG. 25. A base station 2501, as a general base station, includes a wireless antenna 2502 and a network interface 2503 for having communications with the upper router. Furthermore, in this Embodiment, the base station 2501 includes a forwarding unit 2505 which has a buffer 2504 for forwarding. It is supposed that, when a packet is transmitted from the antenna 2502, the packet is to be stored in the buffer 2504 for forwarding till a specified time. By dint of the forwarding unit 2505 forwarding the contents of the buffer 2504 at the request, it is possible to transmit data, which is to be output from the base station 2501 by wireless, to other location within a specific time period.

As shown in FIG. 26, since the data is forwarded from the base station BS2 used before transfer to the base station BS3 used after transfer and the base station BS3 outputs the contents of the data by a wireless unit, the possibility of receiving the packet which the mobile host MH1 could not receive from the base station BS2 during the transfer is increased. Therefore, the packet loss can be reduced.

This procedure will now be explained with reference to FIG. 26. The processing from 2600 to 2604 is the same as that in Embodiment 6. At 2602, the base station BS3 transmits the control message to the router R22 and a message of requesting forward to the base station BS2 used before transfer. The address of the base station used before transfer can be known by the way stated in Embodiment 8. Receiving the message of requesting forward, the base station BS2 forwards the contents of the buffer at 2606.

According to the communications control system of the present Embodiment, a mobile host can receive all the data by dint of a router controlling a control message transmitted from the mobile host.

Embodiment 10

In this Embodiment, the case of a router, whose paths used before transfer and after transfer cross each other, requesting to forward a packet to the network used after transfer will now be explained. The configurations of the mobile host, the router, and the base station according to Embodiment 10 are the same as those in Embodiment 9.

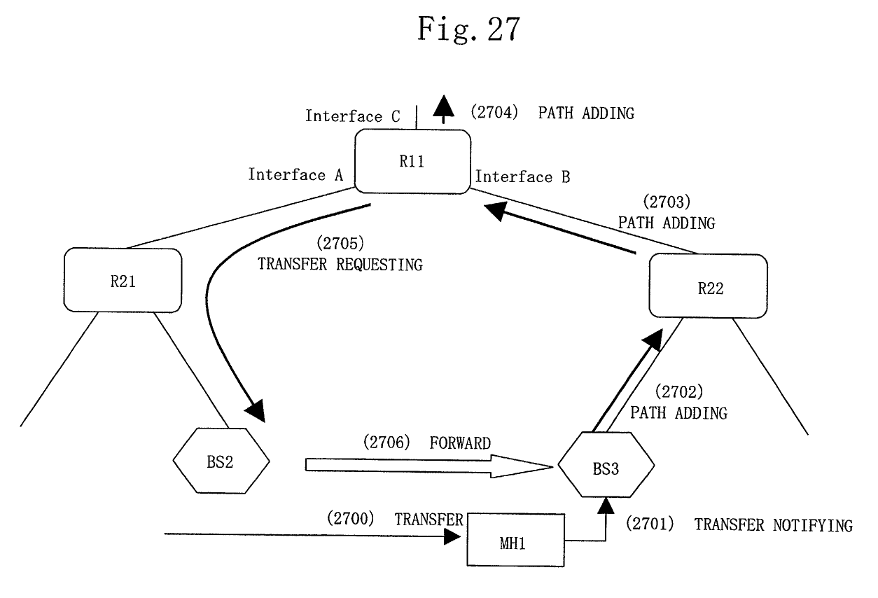

As shown in FIG. 27, the message of requesting forward is transmitted from the router R11 in Embodiment 10, not from the base station BS3 as stated in Embodiment 9. Transmitting the message of requesting forward from the router R11 can be performed through the procedure used in Embodiment 8. Thus, the packet loss can be reduced. Comparing with Embodiment 9, the traffic of the control message between the base station BS3 and the router R11 can also be reduced.

Embodiment 11

In this Embodiment, it will be explained that the notification message of belonging to multicast group is transmitted to the upper router after a response to the message of requesting forward to the network used after transfer is obtained. The configurations of the mobile host, the router, and the base station are the same as those in Embodiment 9.

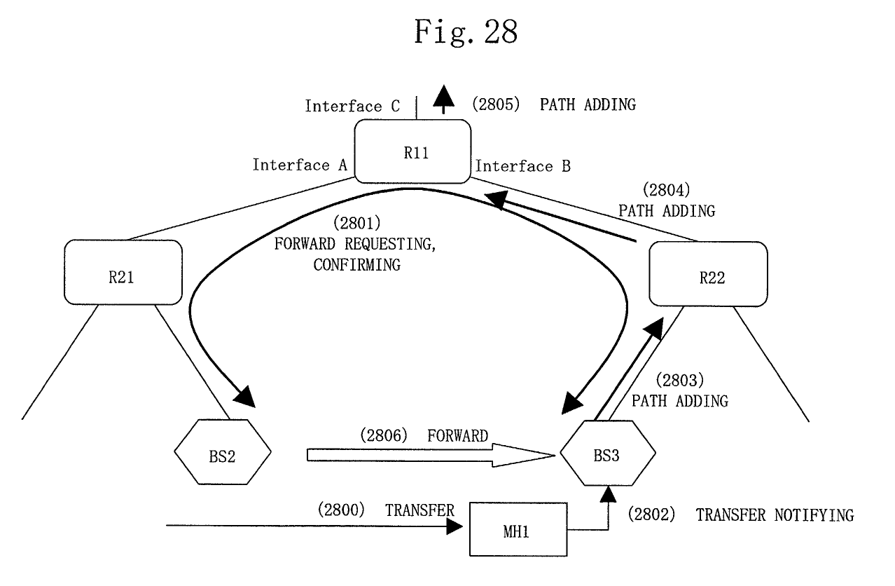

As shown in FIG. 28, the different respect from Embodiment 9 is that forwarding is requested at first at 2801, a confirmation response to the request is received at the base station BS3 at 2801, and then the general control message is transmitted at 2803. In Embodiment 9, the packet, which passes the router R11, is transmitted to the base station BS2, and is forwarded to the base station BS3 before the multicast path table updating, reaches the base station BS3 later than the packet, which passes the router R11 and is transmitted to the base station BS3 just after the multicast path table updating. By dint of firstly requesting forward, it is possible to prevent or lessen the order inversion in receiving packets.

Embodiment 12

In this Embodiment, it will be explained that a router existing in the network used before transfer is informed of the address of the mobile host which has transferred, and the router transmits a notification message of withdrawing from the multicast group if possible, based on the information. The configuration of the router used in this Embodiment is the same as one of the routers used in Embodiments 1 through 6. Each base station includes a table of address of multicast group and address of host belonging to the multicast group.

In Embodiment 6, a multicast address, to which a packet need not to be transmitted because the mobile host has transferred, can be detected by managing the address of the mobile host belonging to the multicast group, based on the protocol such as IGMP in each base station.

In Embodiment 12, a transfer notification message including the address of the mobile host which has transferred is transmitted instead of the message of requesting forward as stated in Embodiment 9. Based on the transfer notification message, the network used before transfer clearly knows that the mobile host has transferred to the network used after transfer. Then, the network used before transfer judges whether or not to transmit a packet addressed to the multicast address which the mobile host wanted to receive. If transmitting is unnecessary, the base station used before transfer promptly transmits a notification message of withdrawing from the multicast group in the same way as Embodiment 6. Thus, it can be avoided to flow data becoming unnecessary in accordance with the transfer.

Embodiment 13

In this Embodiment, the case that a router located where paths used before transfer and after transfer cross each other transmits a transfer notification to the router existing in the network used before transfer will be explained.

Embodiment 12 can be realized by including a table of address of multicast group and address of mobile host belonging to the multicast group in each base station, and by transmitting a transfer notification message including the address of the mobile host which has transferred instead of the message of requesting forward as stated in Embodiment 9. In this Embodiment, the transfer notification message is transmitted from the router where paths used before transfer and after transfer cross each other in the same way as Embodiment 10, which reduces the overhead and the traffic of the control message.

Embodiment 14

In this Embodiment, it will be explained that a notification of transfer possibility is transmitted to a router existing in the pre-scheduled network to which the mobile host is to transfer, and after receiving the notification of transfer possibility, the router transmits a notification message of belonging to multicast group in advance. The configuration of the router according to the present Embodiment is the same as that of Embodiment 6.

If it is possible to infer a base station to which a mobile host transfers, such as the case of wireless base stations being located along a street, the base station can previously transmit a notification message of belonging to multicast group before the mobile host transfers. Thus, a path for transmitting a multicast packet can be previously established and the packet loss can be reduced.

The present Embodiment can be realized by the following procedure. Each base station keeps an address of base station to which the mobile host is to transfer. Whenever a notification message of belonging to multicast group is transmitted from the mobile host, in addition to the general process stated in Embodiment 6, the message is forwarded to the next base station to which the mobile host is to transfer, and the next base station performs the process of adding a multicast path based on the forwarded message.

According to the communications control system of the present Embodiment, a mobile host can receive all the data in the case the mobile host transfers between networks using a path which was previously set.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only, and not intended to be limiting. The invention is limited only as defined in the following claims and the equivalents thereto.

What is claimed is:

1. A communications control system comprising:
a unicast path memory for storing unicast path information which relates to a combination of a host address of a host to which data is transmitted and an output destination interface indicating a network interface used as a path for transmitting the data to the host address;
a multicast group management memory for storing multicast group information which relates to a combination of the host address and a multicast address to which the host belongs;
a multicast path memory for storing multicast path information which relates to a combination of the multicast address and the output destination interface; and
a multicast path controller for obtaining the multicast address and the host address corresponding to the multicast address from the multicast group management memory, obtaining the output destination interface corresponding to an obtained host address from the unicast path memory, and storing a combination of an obtained multicast address and an obtained output destination interface as the multicast path information in the multicast path memory.

2. The communications control system of claim 1 further comprising a multicast group management part for receiving a notification message of belonging to multicast group including the host address and the multicast address, obtaining the host address and the multicast address from a received notification message of belonging to multicast group, and storing a combination of an obtained host address and an obtained multicast address as the multicast group information in the multicast group management memory.

3. The communications control system of claim 2, wherein the multicast group management part broadcasts the received notification message of belonging to multicast group, within a specific range in a network.

4. The communications control system of claim 1 further comprising a unicast path controller for receiving a unicast path control message which notifies a change of the unicast path information, and updating the unicast path information stored in the unicast path memory based on a received unicast path control message,
wherein the multicast path controller updates the multicast path information stored in the multicast path memory when the unicast path information stored in the unicast path memory is updated by the unicast path controller.

5. The communications control system of claim 2, wherein the multicast group management memory further stores a validity period of a combination of the host address and the output destination network corresponding to the host address.

6. The communications control system of claim 2 further comprising a unicast path controller for receiving a unicast path control message which notifies a change of the unicast path information, and updating the unicast path information stored in the unicast path memory based on a received unicast path control message,
wherein the multicast group management part directs the unicast path controller to add a change of the multicast group information to the unicast path control message, and the unicast path controller adds the change of the multicast group information to a received unicast path control message and transmits an added unicast path control message.

7. The communications control system of claim 1 further comprising a unicast path controller for receiving a unicast path control message which notifies a change of the unicast path information including the host address through a network interface, obtaining the host address from a received unicast path control message, detecting the output destination interface from the received unicast path control message, and storing a combination of an obtained host address and a detected output destination interface as the unicast path information in the unicast path memory.

8. The communications control system of claim 4, wherein the unicast path controller regards a network interface which has received the unicast path control message as an output destination interface.

9. The communications control system of claim 2, wherein the host is a mobile host, and the notification message of belonging to multicast group is sent from the mobile host.

10. A communications control system comprising:
a multicast path memory for correspondingly storing a multicast address and an output destination interface indicating a network interface used as a path for transmitting data addressed to the multicast address; and
a multicast path controller for receiving a notification message of belonging to multicast group, which includes the multicast address and indicates that a host address of a host belongs to the multicast address, obtaining the multicast address from a received notification message of belonging to multicast group, detecting the network interface which received the notification message of belonging to multicast group as the output destination interface, and correspondingly storing an obtained multicast address and a detected output destination interface in the multicast path memory.

11. The communications control system of claim 10 further comprising:
a plurality of routers, each of which has the multicast path memory and the multicast path controller, for mediating to transmit data in a specific network; and
a gateway, which has the multicast path memory and the multicast path controller, for connecting the specific network with another network;
wherein each of the plurality of routers receives the notification message of belonging to multicast group and transmits a received notification message of belonging to multicast group to another of the plurality of routers, in order to finally transmit the notification message of belonging to multicast group to the gateway.

12. The communications control system of claim 10, wherein the multicast path memory further stores a validity period of a combination of the multicast address and the output destination network corresponding to the multicast address, and the multicast path controller sets the validity period.

13. The communications control system of claim 12,
wherein the multicast path memory stores a plurality of output destination interfaces for the multicast address, and a plurality of validity periods each of which corresponds to each of the plurality of output destination interfaces; and
when a combination of the obtained multicast address from the received notification message of belonging to multicast group and the detected output destination interface has been already stored in the multicast path memory,
the multicast path controller obtains one of the plurality of validity periods which corresponds to a combination of a stored multicast address and a stored output destination interface, retains the received notification message of belonging to multicast group until a specific time limit within an obtained one of the plurality of validity periods, and transmits a retained notification message of belonging to multicast group at the specific time limit.

14. The communications control system of claim 13, wherein the multicast path controller, in the case of retaining a plurality of notification messages of belonging to multicast group, gathers the plurality of notification messages of belonging to multicast group together to be one message to be transmitted.

15. The communications control system of claim 10, wherein the multicast path controller receives a multicast path management message including a multicast path management notification for managing the multicast path memory, and manages the multicast path memory based on a received multicast path management message.

16. The communications control system of claim 10 further comprising:
a unicast path memory created based on a unicast path control message including a host address of a host to which data is transmitted and an output destination interface indicating a network interface used for transmitting the data to the host address,
wherein the unicast path control message further includes a multicast path management notification for managing the multicast path memory, and the multicast path controller obtains the multicast path management notification from the unicast path control message and controls the multicast path memory based on an obtained multicast path management notification.

17. The communications control system of claim 10, wherein the communications control system receives a transfer notification message including a fixed address of a mobile host which is fixed to the mobile host and a transfer destination address that is corresponding to a network to which the mobile host has transferred,
the transfer notification message further includes a multicast path management notification for managing the multicast path memory, and
the multicast path controller obtains the multicast path management notification from the transfer notification message, and controls the multicast path memory based on an obtained multicast path management notification.

18. The communications control system of claim 15, wherein the multicast path management notification includes one of an addition of the multicast address and a deletion of the multicast address.

19. The communications control system of claim 10, wherein the communications control system receives data transmitted from the mobile host and the notification message of belonging to multicast group is transmitted from the mobile host.

20. A communications control method comprising:
creating a memory area of a unicast path memory;
storing unicast path information which relates to a combination of a host address of a host to which data is transmitted and an output destination interface indicating a network interface used as a path for transmitting the data to the host address, in the unicast path memory;
creating a memory area of a multicast group management memory;
storing multicast group information which relates to a combination of the host address and a multicast address to which the host belongs, in the multicast group management memory;
creating a memory area of a multicast path memory;
obtaining the multicast address and the host address corresponding to the multicast address from the multicast group management memory;
obtaining the output destination interface corresponding to an obtained host address, from the unicast path memory; and
storing an obtained multicast address and an obtained output destination interface as multicast path information in the multicast path memory.
